(19) United States
(12) Patent Application Publication
(10) Pub. No.: US 2011/0190998 A1
(43) Pub. Date: Aug. 4, 2011

(54) AUTOMATIC VEHICLE BRAKING SYSTEM AND METHOD

(75) Inventors: Hidehisa Kato, Shizuoka-ken (JP); Hisashi Kajita, Shizuoka-ken (JP)

(73) Assignee: TOYOTA JIDOSHA KABUSHIKI KAISHA, Toyota-shi (JP)

(21) Appl. No.: 13/059,660

(22) PCT Filed: Sep. 25, 2009
(86) PCT No.: PCT/IB2009/006943

§ 371 Date: Feb. 18, 2011

(30) Foreign Application Priority Data
Sep. 26, 2008 (JP) 2008-247788
Sep. 26, 2008 (JP) 2008-247789

(51) Int. Cl. B60T 7/12; B60T 8/17

(52) U.S. Cl. 701/70

(57) ABSTRACT

Provided in a vehicle, in which front wheels are provided so as to be braked by disc brakes and rear wheels are provided so as to be braked by drum brakes, is an automatic braking control section that controls the deceleration of the vehicle by adjusting only the hydraulic pressure applied to the disc brakes when the automatic braking control is performed. Thus, when the automatic braking control is performed, the braking force of the drum brakes is not adjusted and therefore, it is possible to suppress the instability of the deceleration of the vehicle caused by adjusting the braking force of the drum brakes of which the braking force is difficult to control. As a result, it is possible to stabilize braking when the automatic braking is performed.

### BACKGROUND OF THE INVENTION

1. Field of the Invention

The invention relates to an automatic vehicle braking system and method, and in particular relates to an automatic vehicle braking system and method that perform the automatic braking of a vehicle in which both a disc brake and a drum brake are used.

2. Description of the Related Art

A conventional vehicle includes an automatic vehicle braking system that automatically performs braking as needed, independently of the braking operation by the driver, in order to secure safety during traveling and driving stability. Such an automatic vehicle braking system is used, for example, when traction control is performed that is control performed to suppress wheel spin by reducing the rotation speed of the wheel at which the wheel spin occurs by automatic braking control when the wheel slip due to driving force, which is the wheel spin, occurs because an excessive driving force is applied to the wheel.

Popular brake means installed in a vehicle include the disc brakes and the drum brakes. Some conventional vehicles use both disc brakes and drum brakes, such as in the case where the disc brakes are used for the front wheels and the drum brakes are used for the rear wheels. The drum brake includes a brake drum that rotates with the wheel and brake shoes that press against the brake drum from inside. The drum brake reduces the rotation speed of the brake drum with the use of the friction generated when the brake shoes press against the brake drum from inside, whereby the drum brake generates a braking force. Many of the conventional drum brakes include an auto-adjuster that mechanically performs automatic adjustment of the shoe clearance that is the clearance between the brake drum and the brake shoes and therefore, even when the brake shoes wear, the shoe clearance is prevented from exceeding a predetermined amount.

However, when the brake shoes exert a large pressing force on the brake drum and the brake drum is elastically deformed, or when the brake drum is heated to high temperatures and the brake drum is thermally expanded at the time of braking, the shoe clearance can become large, which can cause the auto-adjuster to be unnecessarily operated. When the auto-adjuster is unnecessarily operated in this way, the shoe clearance can become an inappropriate size and in this case, the desired braking force is not obtained. Thus, there is an automatic vehicle braking system that is devised to more appropriately obtain the braking force of the drum brake during the automatic braking control.

In a system for controlling the braking force in the automatic braking described in Japanese Patent Application Publication No. 2004-149088, for example, the braking force applied when the running conditions of the vehicle are controlled by the automatic braking using the drum brakes is restricted within a range in which excessive automatic adjustment of the shoe clearance due to the operation of the auto-adjuster is not performed. When the braking force during the automatic braking is restricted in this way, it is possible to suppress the excessive automatic adjustment of the shoe clearance and the shoe clearance is therefore kept adequate. Thus, the braking force of the drum brakes is more appropriately obtained.

When the brake means is controlled in this way and the braking is automatically performed independently of the braking operation performed by the driver, in general, the target braking force is derived and the brake means is controlled so as to be able to brake the vehicle according to the braking force derived, whereby the braking force is generated. The actual braking force generated by controlling the brake means in this way can differ from the target braking force and therefore, feedback control is performed to bring the actual braking force to the target braking force. In this way, it is possible to properly brake the vehicle when the braking is automatically performed.

However, the change in the braking force of the drum brake in response to the change in the hydraulic pressure when the hydraulic pressure is applied to generate a braking force is not uniform and therefore, it is difficult to apply a desired braking force when the braking force is generated in the drum brakes by the automatic braking control. Thus, when the automatic braking control is performed in a vehicle in which the front wheels are provided with disc brakes and the rear wheels are provided with drum brakes, it is difficult to control the braking force of the drum brakes and therefore, there has been a case where the deceleration of the vehicle becomes unstable.

Further, because the braking force of the drum brakes is unstable in the early stage of braking, when the disc brakes and the drum brakes are both used in a vehicle, there is a case where the braking force of the drum brakes, of which the braking force has not become stable yet, is also fed back when feedback control is performed during the automatic braking. In this case, the actual braking force that has not become stable yet is fed back and therefore, the target braking force that is corrected according to the feedback also becomes unstable, which can result in a situation where the braking does not become stable and hunting occurs. Thus, brake feeling during the automatic braking can be deteriorated.

### SUMMARY OF THE INVENTION

The invention provides an automatic vehicle braking system that stabilizes braking during automatic braking.

An automatic vehicle braking system according to a first aspect of the invention includes: a plurality of wheels of a vehicle, including a disc-side wheel that is braked by a disc brake and a drum-side wheel that is braked by a drum brake; and an automatic braking control section that performs automatic braking control in which applied force applied to the disc brake and the drum brake is controlled independently of a braking operation performed by a driver of the vehicle when the wheels are braked by the disc brake and the drum brake, and that, during the automatic braking control, makes the degree of contribution of adjustment of the applied force applied to the disc brake to control of deceleration of the vehicle greater than the degree of contribution of adjustment of the applied force applied to the drum brake to the control of the deceleration when the deceleration of the vehicle is controlled.

In this invention, when the automatic braking control is performed, the degree of contribution of the adjustment of the applied force applied to the disc brake to the control of the deceleration is made greater than the degree of contribution of the adjustment of the applied force applied to the drum brake to the control of the deceleration when the deceleration of the vehicle is controlled. Thus, when the automatic braking control is performed, the influence of the braking force of the drum brake on the deceleration of the vehicle is reduced, so that it is possible to suppress the instability of the deceleration of the vehicle caused by adjusting the braking force of the drum brake of which the braking force is difficult to control. As a result, it is possible to stabilize braking when the automatic braking is performed.

In the automatic vehicle braking system according to the first aspect of the invention, during the automatic braking control, the automatic braking control section may control the deceleration by adjusting only the applied force applied to the disc brake.

In this case, when the automatic braking control is performed, the deceleration of the vehicle is controlled by adjusting only the applied force applied to the disc brake, so that it is possible to more reliably suppress the instability of the deceleration of the vehicle caused by adjusting the braking force of the drum brake of which the braking force is difficult to control. As a result, it is possible to more reliably stabilize braking during automatic braking.

In the automatic vehicle braking system according to the first aspect of the invention, during the automatic braking control, the automatic braking control section may maintain the applied force applied to the drum brake at a retention applied force that is a predetermined amount of the applied force.

In this case, when the automatic braking control is performed, the applied force applied to the drum brake is maintained at the retention applied force. Thus, when the automatic braking control is performed, it is possible to control the deceleration of the vehicle by the disc brake while maintaining a certain amount of braking force by the drum brake. As a result, it is possible to stabilize braking while maintaining a desired amount of braking force during automatic braking.

In the automatic vehicle braking system according to the first aspect of the invention, the automatic braking control section may start maintaining the applied force at the retention applied force after a predetermined period of time has elapsed since the automatic braking control was started.

In this case, because the applied force applied to the drum brake is maintained at the retention applied force by starting maintaining the applied force applied to the drum brake after the predetermined period of time has elapsed since the automatic braking control was started, it is possible to more reliably bring the braking force of the drum brake to a desired braking force. Specifically, although the change in the braking force of the drum brake in response to the change in the applied force varies depending on the ranges of the applied force, the braking force increases regardless of the degree of change in the braking force when the applied force is increased. Thus, by increasing the applied force with time after the start of the automatic braking control and starting maintaining the applied force applied to the drum brake after the predetermined period of time has elapsed, it is possible to more reliably bring the applied force to the retention applied force, which is an applied force that can generate a certain amount of braking force by the drum brake. In this way, during the automatic braking control, it is possible to more reliably maintain a certain amount of braking force by the drum brake. As a result, it is possible to stabilize braking while more reliably maintaining a desired braking force during the automatic braking.

The automatic vehicle braking system according to the first aspect of the invention may further include a drum-side applied force detection device that detects the applied force applied to the drum brake, wherein the automatic braking control section starts maintaining the applied force applied to the drum brake at the retention applied force when the applied force applied to the drum brake that is detected by the drum-side applied force detection device becomes the retention applied force.

In this case, because the applied force applied to the drum brake is maintained at the retention applied force by starting maintaining the applied force applied to the drum brake when the applied force applied to the drum brake that is detected by the drum-side applied force detection device has reached the retention applied force, it is possible to more reliably bring the braking force of the drum brake to the desired braking force. Specifically, the drum-side applied force detection device that detects the applied force applied to the drum brake is provided and when the result of the detection by the drum-side applied force detection device becomes the retention applied force, the applied force applied to the drum brake is retained. In this way, it is possible to more reliably maintain this applied force at the retention applied force that is an applied force that can generate a certain braking force in the drum brake. Thus, during the automatic braking control, it is possible to more reliably maintain a certain braking force by the drum brake. As a result, it is possible to stabilize braking while more reliably maintaining a desired braking force during the automatic braking.

In the automatic vehicle braking system according to the first aspect of the invention, the automatic braking control section may gradually bring the applied force applied to the drum brake to the applied force corresponding to the braking operation when the braking operation is performed during the automatic braking control.

In this case, when the driver performs a braking operation during the automatic braking control, the applied force applied to the drum brake is gradually brought to the applied force corresponding to the braking operation, so that it is possible to avoid the situation where the braking force of the drum brake is rapidly brought to the braking force corresponding to the braking operation. As a result, it is possible to stabilize braking during the automatic braking, and suppress the rapid change in deceleration when braking is performed based on a braking operation during the automatic braking.

In the automatic vehicle braking system according to the first aspect of the invention, the disc-side wheel may be provided as a front wheel of the vehicle and the drum-side wheel may be provided as a rear wheel of the vehicle.

In this case, because the disc-side wheel is used as the front wheel of the vehicle and the drum-side wheel is used as the rear wheel of the vehicle, it is possible to easily bring the deceleration of the vehicle closer to a desired deceleration. Specifically, when the vehicle is braked, a larger load is exerted on the front wheel as compared to the rear wheel and therefore, it is possible to make the braking force of the front wheel greater than the braking force of the rear wheel. Thus, the proportion of the braking force of the rear wheel to the braking force of the entire vehicle is less than the proportion of the braking force of the front wheel thereto. Thus, the influence of the braking force of the rear wheel on the braking force of the entire vehicle is relatively small and therefore, it is possible to easily bring the deceleration of the vehicle closer to a desired deceleration even when, during the automatic braking, the braking force of the rear wheel, which is the drum-side wheel, is kept constant and the deceleration of the vehicle is controlled by only the braking force of the front wheel, which is the disc-side wheel. As a result, it is possible to bring the deceleration of the vehicle closer to the desired deceleration while stabilizing braking during the automatic braking.

An automatic vehicle braking system according to a second aspect of the invention includes: a plurality of wheels of a vehicle, including a disc-side wheel that is braked by a disc brake and a drum-side wheel that is braked by a drum brake; a disc-side wheel braking force detection device that detects a braking force of the disc-side wheel; and an automatic braking control section that performs automatic braking control in which applied force applied to the disc brake and the drum brake is controlled independently of a braking operation performed by a driver of the vehicle when the wheels are braked by the disc brake and the drum brake, and that performs feedback control of the applied force based only on the braking force detected by the disc-side wheel braking force detection device.

In the automatic vehicle braking system according to the second aspect of the invention, the automatic braking control section may perform the feedback control of the applied force based only on the braking force detected by the disc-side wheel braking force detection device during a period of time during which a braking force of the drum brake is unstable in the early stage of braking.

In this case, the braking force of the disc-side wheel is detected by the disc-side wheel braking force detection device and when the automatic braking control is performed by the automatic braking control section, the feedback control is performed based only on the result of the detection by the disc-side wheel braking force detection device during the time period during which the braking force of the drum brake is unstable. Thus, the braking force of the drum brake during the time period during which the braking force is unstable is not reflected in the control of the applied force applied to the disc brake and the drum brake, so that it is possible to avoid the situation where the applied force becomes unstable due to the feedback of the unstable braking force and the braking force therefore becomes further unstable. As a result, it is possible to stabilize braking in the early stage of braking during the automatic braking.

In the automatic vehicle braking system according to the second aspect of the invention, a configuration may be employed in which control of the applied force of the disc brake and control of the applied force of the drum brake are not performed independently of each other.

In this case, because the control of the applied force of the disc brake and the control of the applied force of the drum brake are not performed independently, it is easy to control the applied force. Specifically, even when the feedback control is performed based only on the result of the detection by the disc-side wheel braking force detection device during a period of time during which the braking force of the drum brake is unstable, the applied force of the disc brake and the applied force of the drum brake are both controlled by the feedback control using one feedback amount. Thus, it is easy to control the applied force. As a result, it is facilitated to stabilize the braking in the early stage of braking during the automatic braking.

In the automatic vehicle braking system according to the second aspect of the invention, the disc brake and the drum brake may be provided so that the control of the applied force of the disc brake and the control of the applied force of the drum brake can be performed independently of each other.

In this case, the disc brake and the drum brake are provided so that the control of the applied force of the disc brake and the control of the applied force of the drum brake are performed independently of each other and therefore, even during the time period during which the braking force of the drum brake is unstable, braking control for the disc brake can be performed by feedback control. Thus, even during the time period during which the braking force of the drum brake is unstable, it is possible to stabilize the braking force of the disc brake and thus stabilize the braking force of the disc-side wheel. As a result, it is possible to more reliably stabilize the braking in the early stage of braking during the automatic braking.

The automatic vehicle braking system according to the second aspect of the invention may further include a drum-side wheel braking force detection device that detects the braking force of the drum-side wheel, wherein the automatic braking control section performs the feedback control of the applied force using both the braking force detected by the disc-side wheel braking force detection device and the braking force detected by the drum-side wheel braking force detection device after the period of time during which the braking force of the drum brake is unstable has elapsed.

In this ease, after the period of time has elapsed during which the braking force of the drum brake is unstable, the feedback control of the applied force is performed using also the result of the detection of the braking force by the drum-side wheel braking force detection device, so that it is possible to more appropriately control the applied force. Specifically, after the period of time has elapsed during which the braking force of the drum brake is unstable, the braking force exerted by the drum brake is fed back and therefore, when the braking control is performed so that the actual braking force is brought to the target braking force, the actual braking force is more reliably brought closer to the target braking force. As a result, it is possible to perform the braking control during the automatic braking with the braking force as desired while stabilizing the braking in the early stage of braking during the automatic braking.

In the automatic vehicle braking system according to the second aspect of the invention, the disc-side wheel may be provided as a front wheel of the vehicle and the drum-side wheel may be provided as a rear wheel of the vehicle.

In this case, the disc-side wheel is used as the front wheel of the vehicle and the drum-side wheel is used as the rear wheel of the vehicle. Thus, it is possible to bring the braking force in the early stage of braking closer to the target braking force. Specifically, when the vehicle is braked, a larger load is exerted on the front wheel as compared to the rear wheel, and therefore, it is possible to make the braking force of the front wheel greater than the braking force of the rear wheel. Thus, the proportion of the braking force of the rear wheel to the braking force of the entire vehicle is less than the proportion of the braking force of the front wheel thereto. Thus, the influence of the braking force of the rear wheel on the braking force of the entire vehicle is relatively small, so that it is possible to bring the braking force of the entire vehicle closer to the target braking force even when only the braking force of the front wheel, which is the disc-side wheel, is fed back and the braking force of the rear wheel, which is the drum-side wheel, is not fed back in the early stage of braking. As a result, it is possible to bring the braking force in the early stage of braking closer to the desired braking force while stabilizing braking in the early stage of braking during the automatic braking.

An automatic vehicle braking method according to a third aspect of the invention is a method of performing automatic braking of a vehicle that has a plurality of wheels including a disc-side wheel that is braked by a disc brake and a drum-side wheel that is braked by a drum brake, the method including the step of, when the plurality of wheels are braked by the disc brake and the drum brake, controlling applied force applied to the disc brake and the drum brake independently of a braking operation performed by a driver of the vehicle, wherein the degree of contribution of adjustment of the applied force applied to the disc brake to control of deceleration of the vehicle is made greater than the degree of contribution of adjustment of the applied force applied to the drum brake to the control of the deceleration when the deceleration of the vehicle is controlled.

An automatic vehicle braking method according to a fourth aspect of the invention is a method of performing automatic braking of a vehicle that has a plurality of wheels including a disc-side wheel that is braked by a disc brake and a drum-side wheel that is braked by a drum brake, the method including the step of, when the plurality of wheels are braked by the disc brake and the drum brake, controlling applied force applied to the disc brake and the drum brake independently of a braking operation performed by a driver of the vehicle, wherein feedback control of the applied force is performed based only on the braking force detected by a disc-side wheel braking force detection device that detects a braking force of the disc-side wheel.

The automatic vehicle braking system according to the invention brings about the effect that braking during the automatic braking is stabilized.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram of a vehicle provided with an automatic vehicle braking system according to a first embodiment of the invention;

FIG. 2 is a schematic configuration diagram showing a control system of a brake means shown in FIG. 1;

FIG. 3 is a main part configuration diagram of the automatic vehicle braking system shown in FIG. 1;

FIG. 4 is a block diagram, showing a main part of the automatic vehicle braking system shown in FIG. 1, that is an explanatory diagram for explaining the automatic braking control;

FIG. 5 is a flow chart showing a processing procedure of the automatic vehicle braking system according to the first embodiment;

FIG. 6 is a schematic diagram of a vehicle provided with an automatic vehicle braking system according to a modification of the first embodiment;

FIG. 7 is a main part configuration diagram of the automatic vehicle braking system shown in FIG. 6;

FIG. 8 is a schematic diagram of a vehicle provided with an automatic vehicle braking system according to a second embodiment of the invention;

FIG. 9 is a main part configuration diagram of the automatic vehicle braking system shown in FIG. 8;

FIG. 10 is a block diagram, showing a main part of the automatic vehicle braking system shown in FIG. 8, that is an explanatory diagram for explaining the control in the early stage of braking performed by the automatic braking control;

FIG. 11 is a block diagram, showing the main part of the automatic vehicle braking system shown in FIG. 8, that is an explanatory diagram for explaining the control in the case where the automatic braking control is performed for a predetermined period of time;

FIG. 12 is a schematic diagram of a vehicle provided with an automatic vehicle braking system according to a third embodiment of the invention;

FIG. 13 is a main part configuration diagram of the automatic vehicle braking system shown in FIG. 12;

FIG. 14 is an explanatory diagram for explaining the control performed in the early stage of braking when automatic braking control is performed by the automatic vehicle braking system according to the third embodiment; and

FIG. 15 is an explanatory diagram for explaining the control performed after a predetermined period of time has elapsed in the case where the automatic braking control is performed by the automatic vehicle braking system according to the third embodiment.

### DETAILED DESCRIPTION OF EMBODIMENTS

Embodiments of an automatic vehicle braking system according to the invention will be described below in detail with reference to drawings. The invention is not limited to these embodiments.

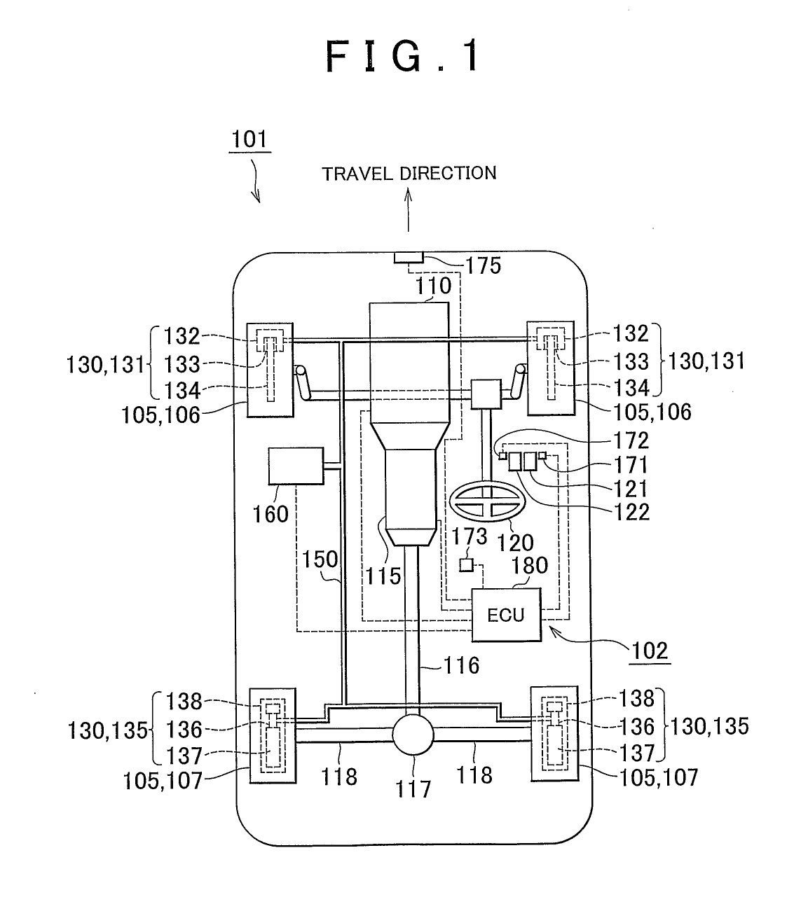

FIG. 1 is a schematic diagram of a vehicle provided with an automatic vehicle braking system according to a first embodiment of the invention. In the following description, the travel direction of the vehicle 101 in the normal running condition is the forward direction and the direction opposite to the travel direction is the backward direction. In the vehicle 101 including the automatic vehicle braking system 102 according to this embodiment, an engine 110, which is an internal combustion engine, is mounted as the motive power generation means in a front area with respect to the travel direction of the vehicle 101. The motive power generated by the engine 110 is changed in speed by an automatic transmission 115 by a speed ratio appropriate to the running conditions. The motive power changed in speed by the automatic transmission 115 is transmitted to, among wheels 105 of the vehicle 101, rear wheels 107 provided as the driving wheels, via a propeller shaft 116, a differential gear 117, and a drive shaft 118, whereby the vehicle 101 is driven.

Although the vehicle 101 including the automatic vehicle braking system 102 according to this embodiment is a so-called Front-engine Rear-drive (FR) type vehicle, in which the engine 110 is mounted in a front area with respect to the travel direction of the vehicle 101 and the rear wheels 107 are provided as the driving wheels, the driving system of the vehicle 101 may differ from the FR type. In this embodiment, the engine 110 is a reciprocating-type, spark-ignited engine, of which the fuel is gasoline. However, the engine is not limited to this. The engine 110 may be a spark-ignited engine of which the fuel is Liquefied Petroleum Gas (LPG), alcohol, or the like, a spark-ignited rotary engine, or a diesel engine. The transmission that changes the speed of rotation of the engine 110 may differ from the automatic transmission 115, that is, the transmission may be a manual transmission that is manually shifted, for example. The vehicle 101 including the automatic vehicle braking system 102 according to this embodiment may be a vehicle, such as a hybrid vehicle (HV), an electric vehicle (EV), a fuel cell vehicle, etc, that uses a motive power generation means that is not the engine 110 that is an internal combustion engine.

Among the wheels 105 that the vehicle 101 has, the rear wheels 107 are provided as the driving wheels, and on the other hand, front wheels 106 are provided as the steered wheels of the vehicle 101. The front wheels 106, which are the steered wheels, are provided so as to be steered by a steering wheel 120 installed at the driver's seat of the vehicle 101.

In the vicinity of each of the wheels 105, a brake 130, which functions as the brake means that applies a braking force to the wheel 105, is provided. In the vicinity of each of the front wheels 106, a disc brake 131, which is the brake 130 that applies a braking force to the front wheel 106, is provided. The disc brake 131 includes a wheel cylinder 132 and brake pads 133, which are provided so as not to rotate, and also includes a brake disc 134, which is provided so as to be able to rotate with the wheel 105. In the vicinity of each of the rear wheels 107, a drum brake 135 is provided, which is the brake 130 that applies a braking force to the rear wheel 107. The drum brake 135 includes a wheel cylinder 136 and brake shoes 137, which are provided so as not to rotate, and also includes a brake drum 138, which is provided so as to be able to rotate with the wheel 105. Thus, the front wheels 106 are disc-side wheels that are braked by the disc brakes 131 and the rear wheels 107 are drum-side wheels that are braked by the drum brakes 135.

The disc brakes 131 and the drum brakes 135 are connected to a hydraulic system 150 composed of lines for applying hydraulic pressure to the disc brakes 131 and the drum brakes 135 when the vehicle 101 is braked. Specifically, the wheel cylinders 132 of the disc brakes 131 and the wheel cylinders 136 of the drum brakes 135 are connected to the hydraulic system 150. The hydraulic system 150 is provided with a brake actuator 160 that controls the hydraulic pressure in the hydraulic system 150 when the vehicle 101 is braked. The brake actuator 160 applies hydraulic pressure, which is used as the applied force that is applied to the disc brakes 131 and the drum brakes 135, separately to the disc brakes 131 and the drum brakes 135, which are provided in the vicinity of the respective wheels 105. Thus, it is possible to generate the braking force for each of the plurality of wheels 105 independently.

In the vehicle 101, an accelerator pedal 121 operated when the output power from the engine 110 is controlled and a brake pedal 122 operated when the running vehicle 101 is braked are both provided close to the feet of the driver who sits on the driver's seat of the vehicle 101. An accelerator pedal depression amount sensor 171, which functions as the accelerator pedal depression amount detection means that detects the amount of depression of the accelerator pedal 121, is provided. In the vicinity of the brake pedal 122, a brake pedal travel sensor 172, which functions as the brake pedal travel detection means that detects the travel of the brake pedal 122, is provided. In addition, a G sensor 173, which functions as the deceleration detection means that detects at least the longitudinal acceleration of the vehicle 101, is provided.

At the front end of the vehicle 101 with respect to the travel direction, a radar 175 directed forward is disposed as the travel direction conditions detection means for detecting the conditions in an area in the travel direction. The radar 175 includes a radiating section (not shown) that radiates electromagnetic waves in the travel direction of the vehicle 101 and a detection section (not shown) that, when the electromagnetic waves radiated from the radiating section are reflected by an obstacle located in the travel direction of the vehicle 101, detects the reflected electromagnetic waves. The radar 175 is provided so as to be able to detect the conditions in an area in the travel direction of the vehicle 101 by detecting the electromagnetic waves that are radiated from the radiating section and reflected by an obstacle.

The travel direction conditions detection means may differ from the radar 175. For example, the travel direction conditions detection means may be a charge coupled device (CCD) camera capable of detecting the conditions in an area in the travel direction of the vehicle 101 in the form of picked-up image information, for example. The travel direction conditions detection means is not limited as long as it can detect the conditions in an area in the travel direction of the vehicle 101.

The engine 110, the automatic transmission 115, the brake actuator 160, the accelerator pedal depression amount sensor 171, the brake pedal travel sensor 172, the G sensor 173, and the radar 175 are connected to an electronic control unit (ECU) 180 that is installed in the vehicle 101 and controls respective portions of the vehicle 101.

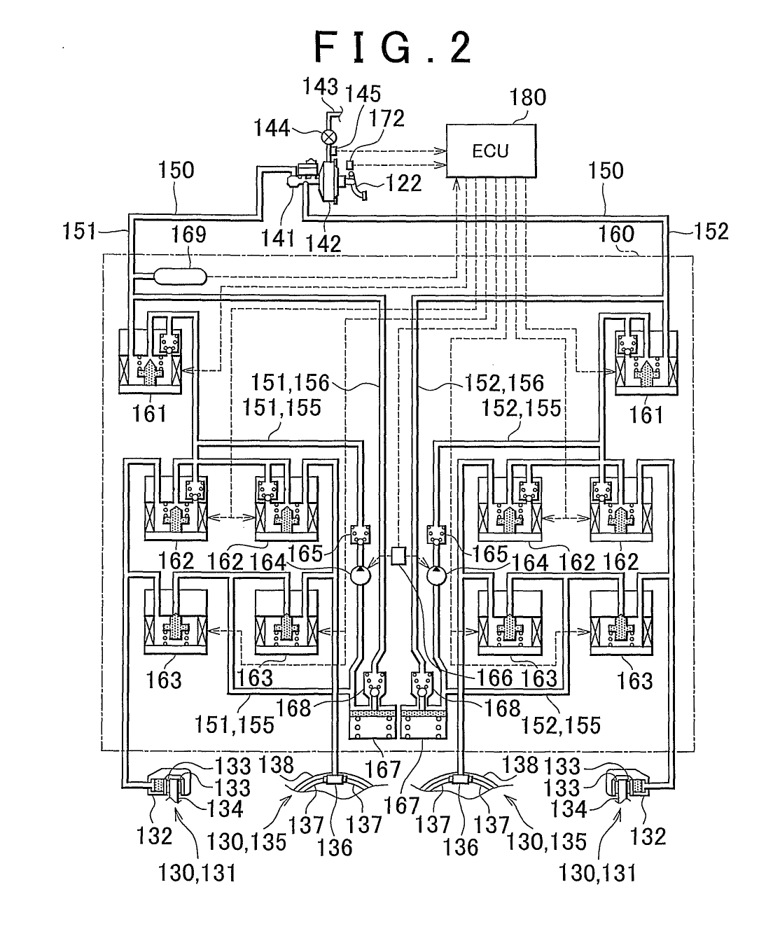

FIG. 2 is a schematic configuration diagram showing a control system of the brake means shown in FIG. 1. The brake pedal 122 operated when the vehicle 101 is braked (see FIG. 1) is connected to a brake booster 142 to which a negative pressure line 143 is connected that is connected to an intake passage (not shown) of the engine 110 (see FIG. 1) and is thus capable of transmitting the negative pressure generated when the engine 110 operates. The negative pressure line 143 connected to the brake booster 142 is provided with a negative pressure line check valve 144 that is a check valve that blocks the airflow from the intake passage side to the brake booster 142 and a negative pressure sensor 145, which functions as the negative pressure detection means that detects the negative pressure in the negative pressure line 143.

The brake booster 142 is connected to a master cylinder 141 capable of generating hydraulic pressure. The hydraulic system 150 is connected to the master cylinder 141. The hydraulic system 150 connected to the master cylinder 141 is filled with a brake fluid used as hydraulic fluid. The hydraulic system 150 is divided into two systems. A first hydraulic system 151 and a second hydraulic system 152, which are the two systems of the hydraulic system 150, are separately connected to the master cylinder 141.

The brake pedal 122 is connected to the hydraulic system 150 via the brake booster 142 and the master cylinder 141. The brake booster 142 is a well-known vacuum servo unit, which is provided so as to be able to transmit, to the master cylinder 141, the pedal depression force input through the brake pedal 122 that is increased with the use of the difference between the atmospheric pressure and the negative pressure transmitted from the negative pressure line 143. The master cylinder 141 is provided so as to be able to generate hydraulic pressure with the use of the force transmitted from the brake booster 142 and transmit the generated hydraulic pressure to the hydraulic system 150.

The brakes 130 are connected to ends of the hydraulic system 150 connected to the master cylinder 141. The first hydraulic system 151 and the second hydraulic system 152 are connected to the brakes 130 that are provided in the vicinity of the wheels 105 that are located at staggered positions in the vehicle 101, respectively. More specifically, connected to the first hydraulic system 151 are the wheel cylinder 132 of the disc brake 131 provided for the left side one of the right and left front wheels 106 and the wheel cylinder 136 of the drum brake 135 provided for the right side one of the right and left rear wheels 107. On the other hand, connected to the second hydraulic system 152 are the wheel cylinder 132 of the disc brake 131 provided for the right side one of the right and left front wheels 106 and the wheel cylinder 136 of the drum brake 135 provided for the left side one of the right and left rear wheels 107.

The hydraulic system 150 is provided with a plurality of solenoid valves, which function as the brake actuator 160. More specifically, the hydraulic system 150 is provided with master cut solenoid valves 161, pressure retaining solenoid valves 162, and pressure reducing solenoid valves 163, the master cut solenoid valves 161 and the pressure retaining solenoid valves 162 being normally-open solenoid valves, the pressure reducing solenoid valves 163 being normally-closed solenoid valves. The master cut solenoid valves 161, the pressure retaining solenoid valves 162, and the pressure reducing solenoid valves 163 are provided as the applied force distribution control means that controls the distribution of the hydraulic pressure applied to the disc brakes 131 and the drum brakes 135. One master cut solenoid valve 161 is provided for each of the first and second hydraulic systems 151 and 152.

In the hydraulic system 150, the pressure retaining solenoid valves 162 are provided in the lines from the master cylinder 141 to the disc brakes 131 and the drum brakes 135 through the master cut solenoid valves 161. Four pressure retaining solenoid valves 162 are provided corresponding to the four brakes 130.

The pressure reducing solenoid valves 163 are provided in returning lines 155 each branched off from the line from the pressure retaining solenoid valve 162 to the brake 130 and connected to the line connecting between the master cut solenoid valve 161 and the pressure retaining solenoid valve 162. In this way, the returning lines 155 in which the pressure reducing solenoid valves 163 are provided are branched off from the lines connecting between the four pressure retaining solenoid valves 162 and the brakes 130, and the pressure reducing solenoid valves 163 are provided in the branched-off lines. Thus, four pressure reducing solenoid valves 163 are provided in the hydraulic system 150. Specifically, as in the case of the pressure retaining solenoid valves 162, four pressure reducing solenoid valves 163 are provided corresponding to the four brakes 130.

With regard to the returning lines 155, downstream of the pressure reducing solenoid valves 163, that is, on the side closer to the point connected to the line between the master cut solenoid valve 161 and the pressure retaining solenoid valves 162 relative to the pressure reducing solenoid valves 163, two returning lines 155 in the first hydraulic system 151 are connected into one line and two returning lines 155 in the second hydraulic system 152 are connected into one line. In the portion of the returning line 155 connected into one line, a compressor pump 164, which functions as the brake actuator 160, and a returning line check valve 165, which is a check valve provided in the returning line 155 are provided. The returning line check valve 165 is provided in the returning line 155 on the side closer to the point connected to the line between the master cut solenoid valve 161 and the pressure retaining solenoid valve 162 relative to the compressor pump 164.

Among these elements, the compressor pump 164 is connected with a driving motor 166 and the compressor pump 164 is provided so as to be driven by the driving motor 166 to supply the brake fluid in the returning lines 155 from the pressure reducing solenoid valve 163 side to the master cut solenoid valve 161 side or the pressure retaining solenoid valve 162 side. The returning line check valve 165 allows the brake fluid to flow in the direction from the compressor pump 164 to the master cut solenoid valve 161 or the pressure retaining solenoid valve 162 and blocks the flow of the brake fluid in the opposite direction. Because the compressor pump 164 and the returning line check valve 165 are provided in this way, these are provided for each of the first hydraulic system 151 and the second hydraulic system 152. Thus, in total, two compressor pumps 164 and two returning line check valves 165 are provided.

A supply line 156, which is a line connected to the returning line 155, is branched off from the portion on the upstream side of the master cut solenoid valve 161 in the hydraulic system 150, that is, the portion between the master cylinder 141 and the master cut solenoid valve 161 in the hydraulic system 150. The supply lines 156 are connected to the returning lines 155. In the supply line 156, a reservoir 167 and a supply line check valve 168, which is a check valve provided in the supply line 156, are provided. The supply line check valve 168 is provided on the side closer to the point connected to the line between the master cylinder 141 and the master cut solenoid valve 161 relative to the reservoir 167 in the supply line 156.

The reservoir 167 is provided so as to be able to store a predetermined amount of brake fluid that flows through the supply lines 156. The supply line check valve 168 allows the brake fluid to flow in the direction from the master cut solenoid valve 161 side or the pressure retaining solenoid valve 162 side to the returning line 155 and blocks the flow of the brake fluid in the opposite direction. Because the reservoir 167 and the supply line check valve 168 are provided in this way, these are provided for each of the first hydraulic system 151 and the second hydraulic system 152. Thus, in total, two reservoirs 167 and two supply line check valves 168 are provided.

A master cylinder pressure sensor 169, which functions as the operation pressure detection means, is provided between the master cylinder 141 and the master cut solenoid valve 161 in the first hydraulic system 151. The master cylinder pressure sensor 169 is provided so as to be able to detect the hydraulic pressure between the master cylinder 141 and the master cut solenoid valve 161 in the first hydraulic system 151 as the operation pressure that is caused when the driver operates the brake pedal, that is, depresses the brake pedal 122.

The negative pressure sensor 145, the master cylinder pressure sensor 169, the master cut solenoid valves 161, the pressure retaining solenoid valves 162, the pressure reducing solenoid valves 163, and the driving motor 166 provided in this way are connected to the ECU 180 and controlled by the ECU 180.

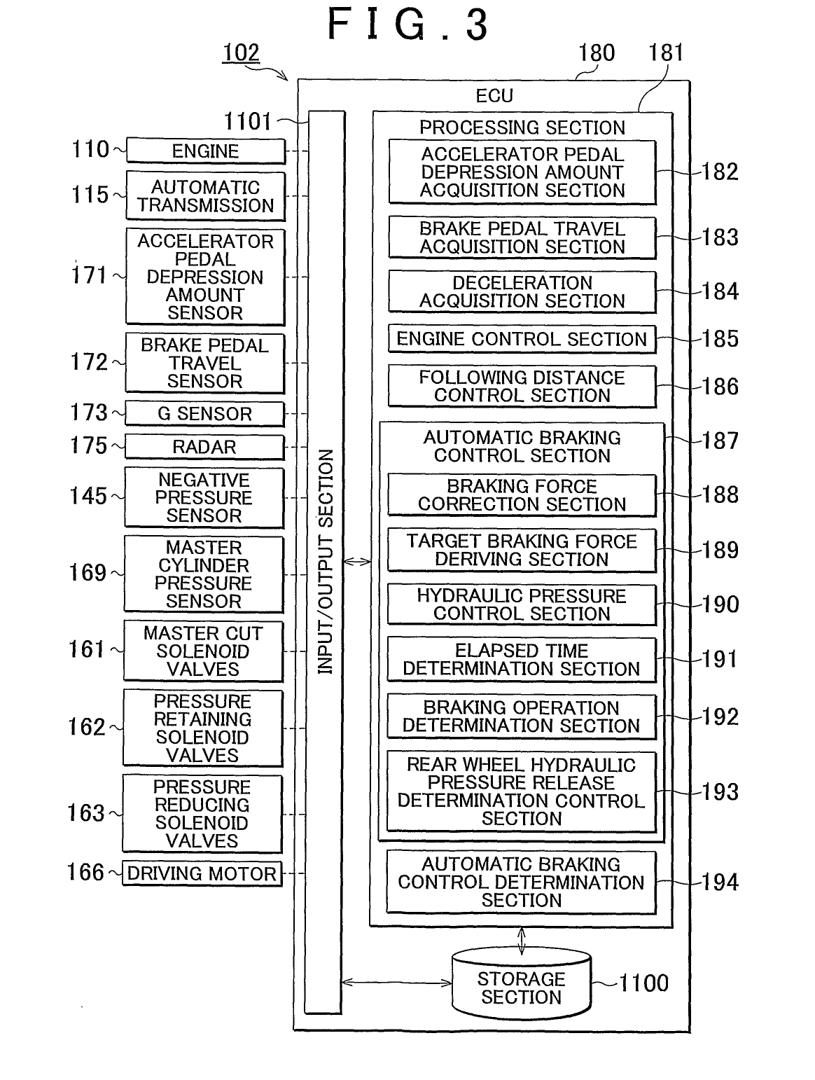

FIG. 3 is a main part configuration diagram of the automatic vehicle braking system shown in FIG. 1. The ECU 180 includes a processing section 181, a storage section 1100, and an input/output section 1101, which are connected to each other and signals are exchanged therebetween. The engine 110, the automatic transmission 115, the accelerator pedal depression amount sensor 171, the brake pedal travel sensor 172, the G sensor 173, the radar 175, the negative pressure sensor 145, the master cylinder pressure sensor 169, the master cut solenoid valves 161, the pressure retaining solenoid valves 162, the pressure reducing solenoid valves 163, and the driving motor 166, which are connected to the ECU 180, are connected to the input/output section 1101. The input/output section 1101 supplies and receives signals to and from these sensors, etc. The storage section 1100 stores a computer program for controlling the automatic vehicle braking system 102. The storage section 1100 can be a hard disk drive, a magneto-optical disk device, a nonvolatile memory such as a flash memory (a read-only storage medium such as a CD-ROM), or a volatile memory such as a random access memory (RAM), or the storage section 1100 can be constructed as a combination of these memories.

The processing section 181 is made up of a memory and a central processing unit (CPU) and at least includes: an accelerator pedal depression amount acquisition section 182, which functions as the accelerator pedal operation amount acquisition means that acquires the amount of depression of the accelerator pedal from the result of the detection by the accelerator Pedal depression amount sensor 171; a brake pedal travel acquisition section 183, which serves as the brake operation amount acquisition means that acquires the travel of the brake pedal 122 from the result of the detection by the brake pedal travel sensor 172; and a deceleration acquisition section 184, which functions as the deceleration acquisition means that acquires the deceleration of the vehicle 101 from the result of the detection by the G sensor 173.

In addition, the processing section 181 includes: an engine control section 185, which functions as the engine control means that controls the operating conditions of the engine 110; and a following distance control section 186, which functions as the following distance control means that performs control to keep the following distance between the host vehicle and a vehicle running ahead of the host vehicle appropriate based on the result of the detection by the radar 175 and deriving the target braking force for keeping the following distance between the host vehicle and the vehicle running ahead of the host vehicle appropriate.

The processing section 181 also includes: an automatic braking control section 187, which functions as the automatic braking control means that performs automatic braking control in which the hydraulic pressure applied to the disc brakes 131 and the drum brakes 135 when the wheels 105 are braked by the disc brakes 131 and the drum brakes 135 is controlled independently of the braking operation by the driver of the vehicle 101, and that makes the degree of contribution of the adjustment of the applied force applied to the disc brakes 131 to the control of the deceleration greater than the degree of contribution of the adjustment of the applied force applied to the drum brakes 135 to the control of the deceleration when deceleration of the vehicle 101 is controlled; and an automatic braking control determination section 194, which functions as the automatic braking control determination means that determines whether the automatic braking control section 187 is performing automatic braking control.

The automatic braking control section 187 included in the processing section 181 includes: a braking force correction section 188, which functions as the braking force correction means that corrects the target braking force derived by the following distance control section 186, based on the deceleration of the vehicle 101 acquired by the deceleration acquisition section 184; a target hydraulic pressure deriving section 189, which functions as the target applied force deriving means that derives the hydraulic pressure that provides the applied force required to generate the target braking force in the disc brakes 131 and the drum brakes 135; a hydraulic pressure control section 190, which functions as the applied force control means that controls the hydraulic pressure that provides the applied force applied to the disc brakes 131 and the drum brakes 135; an elapsed time determination section 191, which functions as the elapsed time determination means that determines whether a predetermined period of time has elapsed since the automatic braking control section 187 started the automatic braking control; a braking operation determination section 192, which functions as the braking operation determination means that determines whether the driver is performing a braking operation; and a rear-wheel hydraulic pressure release determination control section 193, which functions as the drum brake applied force release determination control means that performs the drum brake applied force release determination control, in which the hydraulic pressure applied to the drum brakes 135 is gradually brought closer to the hydraulic pressure corresponding to the braking operation when the driver performs a braking operation while the hydraulic pressure applied to the drum brakes 135 is maintained at a predetermined hydraulic pressure.

The automatic vehicle braking system 102 controlled by the ECU 180 is controlled by operating the brake actuator 160 etc. in accordance with the result of computation performed by the processing section 181 after the processing section 181 reads the computer program into the memory incorporated into the processing section 181 and performs computation, based on the result of the detection by the radar 175, etc. for example. During this process, the processing section 181 stores intermediate values obtained in the computation into the storage section 1100 and reads out the stored values to perform the computation. When the automatic vehicle braking system 102 is controlled in this way, the control may be performed using dedicated hardware separate from the ECU 180 instead of using the computer program.

The automatic vehicle braking system 102 according to this embodiment is configured as described above and the operation thereof will be described below. When the vehicle 101 is running, the engine 110 is operated and the motive power from the engine 110 is transmitted to the rear wheels 107, which are driving wheels. More specifically, while the engine 110 is in operation, rotation of the crankshaft (not shown) that the engine 110 has is transmitted to the automatic transmission 115 and the speed is changed by the automatic transmission 115 by a ratio appropriate to the traveling conditions of the vehicle 101. The rotation changed in speed by the automatic transmission 115 is transmitted to the rear wheels 107 through the propeller shaft 116, the differential gear 117, and the drive shaft 118. Thus, the rear wheels 107, which are the driving wheels, rotate and the vehicle 101 runs.

The vehicle speed of the vehicle 101 that is driven by the rotation of the engine 110 transmitted to the rear wheels 107 is controlled by adjusting the speed and power of the engine 110 by operating the accelerator pedal 121 with a foot. When the accelerator pedal 121 is operated, the travel of the accelerator pedal 121, that is, the accelerator pedal depression amount is detected by the accelerator pedal depression amount sensor 171 provided in the vicinity of the accelerator pedal 121. The result of detection by the accelerator pedal depression amount sensor 171 is transmitted to and acquired by the accelerator pedal depression amount acquisition section 182 that the processing section 181 of the ECU 180 has, and the acquired accelerator pedal depression amount is transmitted to the engine control section 185 that the processing section 181 of the ECU 180 has. The engine control section 185 controls the engine 110 based on the accelerator pedal depression amount acquired by the accelerator pedal depression amount acquisition section 182 and on the results of detection by other sensors.

In order to reduce the vehicle speed by the amount greater than the amount of reduction in speed caused by a release of the accelerator pedal 121 while the vehicle 101 is running, the vehicle 101 is braked by depressing the brake pedal 122. When the braking operation is performed by depressing the brake pedal 122, the depression force is transmitted to the brake booster 142. The negative pressure line 143 is connected to the brake booster 142 and the brake booster 142 is provided so that the negative pressure generated during intake strokes while the engine 110 is in operation is transmitted to the brake booster 142 via the negative pressure line 143. Thus, when the depression force is input to the brake booster 142, the brake booster 142 boosts the depression force by the differential pressure between the negative pressure and the atmospheric pressure and inputs the boosted force to the master cylinder 142. The master cylinder 141 to which the force obtained by boosting the depression force is input applies a pressure to the brake fluid according to the input force to increase the master cylinder hydraulic pressure.

When the master cylinder hydraulic pressure increases, the pressure of the brake fluid in the hydraulic system 150 also increases and the hydraulic pressure in the hydraulic system 150 becomes equal to the master cylinder hydraulic pressure. When the hydraulic pressure in the hydraulic system 150 increases in this way, the hydraulic pressure is also transmitted to the brakes 130 through the master cut solenoid valves 161 and the pressure retaining solenoid valves 162, which are normally-open solenoid valves. In this case, because the pressure reducing solenoid valves 163 are normally closed, the brake fluid in the hydraulic system 150 does not flow from the pressure retaining solenoid valve 162 side into the returning lines 155 through the pressure reducing solenoid valves 163, and therefore, the hydraulic pressure transmitted from the pressure retaining solenoid valves 162 to the brakes 130 is not reduced.

When the increased hydraulic pressure is transmitted to the brakes 130 and the hydraulic pressure is applied thereto, the brakes 130 are actuated by the applied hydraulic pressure. Specifically, in the brakes 130, the wheel cylinders 132 of the disc brakes 131 and the wheel cylinders 136 of the drum brakes 135 are actuated by the master cylinder hydraulic pressure. When these wheel cylinders 132 and 136 are actuated, the wheel cylinders 132 and 136 reduce the rotation speed of the brake discs 134 and the brake drums 138 that are provided associated with the wheel cylinders 132 and 136 and that rotate with the wheels 105 when the wheels 105 rotate.

Specifically, when the hydraulic pressure is applied to the wheel cylinders 132 of the disc brakes 131 and the wheel cylinders 132 of the disc brakes 131 are thus actuated, pressing force is applied to the brake pads 133 to squeeze the brake discs 134 from opposite sides thereof. Thus, the rotation speed of the brake discs 134 is reduced by the friction between the brake discs 134 and the brake pads 133. When the hydraulic pressure is applied to the wheel cylinders 136 of the drum brakes 135 and the wheel cylinders 136 of the drum brakes 135 are thus actuated, pressing force is applied to the brake shoes 137 to press against the brake drums 138 from inside. Thus, the rotation speed of the brake drums 138 is reduced by the friction between the brake drums 138 and the brake shoes 137.

As described above, when the wheel cylinders 132 of the disc brakes 131 and the wheel cylinders 136 of the drum brakes 135 are actuated by the master cylinder hydraulic pressure, the rotation speed of the brake discs 134 and the brake drums 138 is reduced and the rotation speed of the wheels 105 is also reduced. Specifically, when the rotation speed of the brake discs 134 is reduced, the rotation speed of the front wheels 106 that rotate with the brake discs 134 is reduced, and when the rotation speed of the brake drums 138 is reduced, the rotation speed of the rear wheels 107 that rotate with the brake drums 138 is reduced. Thus, the vehicle 101 is decelerated and deceleration occurs in the vehicle 101.

When the vehicle 101 is braked, in the brakes 130, a braking force is generated that is a force to reduce the rotation speed of the brake discs 134 and the brake drums 138 when the brake pedal 122 is operated. Thus, with the use of such reduction of the rotation speed, the rotation speed of the wheels 105 is reduced and the running vehicle 101 is braked.

When the brake pedal 122 is operated in this way, the travel of the brake pedal 122 is detected by the brake pedal travel sensor 172 provided in the vicinity of the brake pedal 122. The result of detection by the brake pedal travel sensor 172 is acquired by the brake pedal travel acquisition section 183 that the processing section 181 of the ECU 180 has. The hydraulic pressure control section 190 that the processing section 181 of the ECU 180 has controls the brake actuator 160 based on the travel of the brake pedal 122 acquired by the brake pedal travel acquisition section 183 and on the result of the detection by other sensors provided in the vehicle 101, thereby controlling the hydraulic pressure applied to the brakes 130.

The vehicle 101 including the automatic vehicle braking system 102 according to this embodiment is capable of performing the adaptive cruise control (ACC). For example, the ACC allows the vehicle 101 to follow a vehicle running ahead of the host vehicle 101 while keeping a certain following distance, and when the distance between the host vehicle and the vehicle ahead of the host vehicle is small, the ACC performs the automatic braking control for automatic braking. When the ACC is performed, the following distance between the host vehicle and the vehicle ahead of the host vehicle is detected by the radar 175 provided at the front end of the vehicle 101 and the control is performed based on the detected distance.

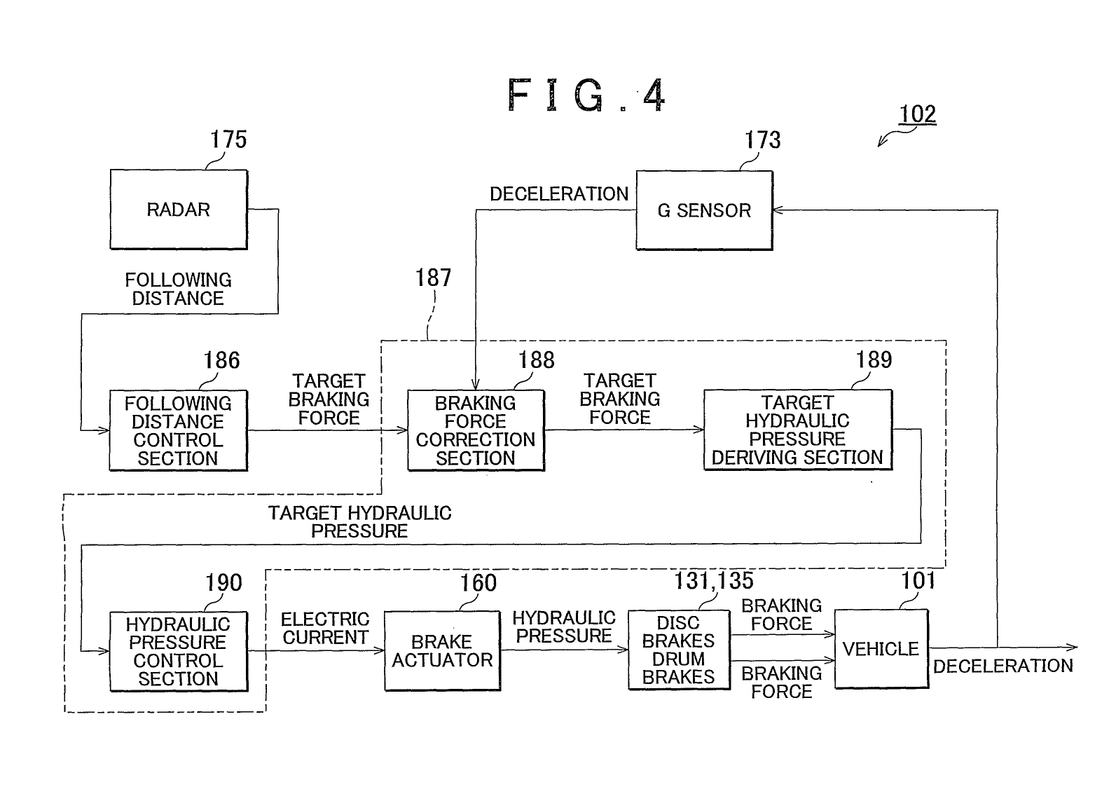

FIG. 4 is a block diagram, showing a main part of the automatic vehicle braking system shown in FIG. 1, that is an explanatory diagram for explaining the automatic braking control. When a braking is performed by a braking operation by the driver while the vehicle 101 is running, the braking is performed by operating the brake pedal 122 as described above. In this case, the automatic braking control in the ACC control is performed by the automatic braking control section 187 that the processing section 181 of the ECU 180 has, based on the result of the detection by the radar 175. When the automatic braking control section 187 performs the automatic braking control, the following distance between the host vehicle 101 and the vehicle running ahead of the host vehicle 101 with the use of the radar 175. The following distance detected by the radar 175 is transmitted to the following distance control section 186 that the processing section 181 of the ECU 180 has. In the following distance control section 186, the target braking force corresponding to the following distance is derived from the following distance detected by the radar 175. Specifically, when the following distance transmitted from the radar 175 is equal to or less than a predetermined following distance, the deceleration required to increase the following distance is derived and the target braking force required to decelerate the vehicle 101 by this deceleration is derived.

The predetermined following distance used in this determination is set for each vehicle speed in advance and stored in the storage section 1100 of the ECU 180. Also in the case of deceleration, the decelerations associated with the following distances and the vehicle speeds are set in the form of a map in advance and stored in the storage section 1100.

The target braking force derived in the following distance control section 186 is transmitted to the automatic braking control section 187 that the processing section 181 of the ECU 180 has. Specifically, the target braking force is transmitted to the braking force correction section 188 that the automatic braking control section 187 has. The braking force correction section 188 corrects the target braking force transmitted from the following distance control section 186, based on the deceleration acquired by the deceleration acquisition section 184. While the vehicle 101 is running, the acceleration that acts on the vehicle 101 is detected by the G sensor 173, the detection result is acquired by the deceleration acquisition section 184 that the processing section 181 of the ECU 180 has, and the deceleration acquisition section 184 acquires the acceleration in the rearward direction of the vehicle 101 as the deceleration that acts on the vehicle 101. The braking force correction section 188 corrects the target braking force transmitted from the following distance control section 186, based on this deceleration acquired by the deceleration acquisition section 184. The target braking force corrected by the braking force correction section 188 is transmitted to the target hydraulic pressure deriving section 189 that the automatic braking control section 187 has.

The target hydraulic pressure deriving section 189 to which the target braking force has been transmitted derives the hydraulic pressure required to generate the target braking force by the disc brakes 131 and the drum brakes 135, that is, the target hydraulic pressure, which is the hydraulic pressure that can generate the target braking force by applying the hydraulic pressure to the disc brakes 131 and the drum brakes 135. With regard to the method of deriving the target hydraulic pressure by the target hydraulic pressure deriving section 189, a brake inverse model (not shown) made up of the relation between the braking force and the hydraulic pressure is stored in the storage section 1100 of the ECU 180 in advance, and the hydraulic pressure corresponding to the target braking force is derived from the target braking force transmitted from the braking force correction section 188 and the brake inverse model stored in the storage section 1100. This is used as the target hydraulic pressure. The target hydraulic pressure derived by the target hydraulic pressure deriving section 189 is transmitted to the hydraulic pressure control section 190 that the automatic braking control section 187 has.

The hydraulic pressure control section 190 to which the target hydraulic pressure has been transmitted derives the amount of electric current that can operate the brake actuator 160 by the amount of work that can generate the target hydraulic pressure and supplies the electric current to the brake actuator 160. The brake actuator 160 that receives the electric current from the hydraulic pressure control section 190 is operated by this electric current. When the automatic braking control is performed in the automatic braking control section 187, the compressor pump 164 is activated by activating the driving motor 166. The activation of the compressor pump 164 causes the brake fluid in the returning line 155 to flow in the direction toward the line between the master cut solenoid valve 161 and the pressure retaining solenoid valves 162. Thus, it is possible to pressurizing the brake fluid that flows in the direction of the pressure retaining solenoid valves 162 to increase the hydraulic pressure applied to the disc brakes 131 and the drum brakes 135 even when the braking operation by the driver is not being performed. Accordingly, when the brake actuator 160 is operated, the brake actuator 160 can apply the hydraulic pressure corresponding to the amount of work to the disc brakes 131 and the drum brakes 135. In this case, the hydraulic pressure has already been brought to a hydraulic pressure substantially equal to the target hydraulic pressure.

The hydraulic pressure adjusted by the brake actuator 160 is transmitted and applied to the disc brakes 131 and the drum brakes 135 via the hydraulic system 150. The disc brakes 131 and the drum brakes 135 are actuated by this hydraulic pressure and generate braking force. The braking force generated by the disc brakes 131 is used as the braking force of the front wheels 106 and the braking force generated by the drum brakes 135 is used as the braking force of the rear wheels 107. Such braking force reduces the rotation speed of the wheels 105 and deceleration corresponding to the braking force occurs in the vehicle 101.

When the braking control is performed by the automatic braking control section 187, the braking force generated by the disc brakes 131 and the drum brakes 135 is adjusted so that the deceleration derived by the following distance control section 186 is obtained. In this case, the hydraulic pressure applied to the drum brakes 135 is maintained at a predetermined hydraulic pressure. Thus, when the automatic braking control is performed, the deceleration of the vehicle 101 is controlled by adjusting the hydraulic pressure applied to the disc brakes 131. Specifically, when the automatic braking control is performed, the control is performed so that the degree of contribution of the adjustment of the applied force applied to the disc brakes 131 to the control of the deceleration is made greater than the degree of contribution of the adjustment of the applied force applied to, the drum brakes 135 to the control of the deceleration when deceleration of the vehicle 101 is controlled, whereby the deceleration of the vehicle 101 is brought to the deceleration derived by the following distance control section 186 by adjusting only the braking force generated by the disc brakes 131. In this way, when the automatic braking control is performed, the automatic braking control section 187 maintains the hydraulic pressure applied to the drum brakes 135 at a predetermined hydraulic pressure and increases the degree of contribution of the braking force of the disc brakes 131 to the braking force of the whole vehicle 101 by adjusting the hydraulic pressure applied to the disc brakes 131, and in addition, the automatic braking control section 187 also makes the degree of contribution of the adjustment of the applied force applied to the disc brakes 131 to the amount of control of deceleration greater than the degree of contribution of the adjustment of the applied force applied to the drum brakes 135 thereto.

When the braking operation by the driver is performed during the automatic braking control, the automatic braking control section 187 performs control in which the hydraulic pressure applied to the drum brakes 135 is gradually brought closer to the hydraulic pressure corresponding to the braking operation. Specifically, while the automatic braking control is performed, the hydraulic pressure applied to the drum brakes 135 is maintained at the predetermined hydraulic pressure, and when a braking operation by the driver is performed, the hydraulic pressure applied to the drum brakes 135 is gradually brought from the maintained hydraulic pressure to the hydraulic pressure corresponding to the braking operation.

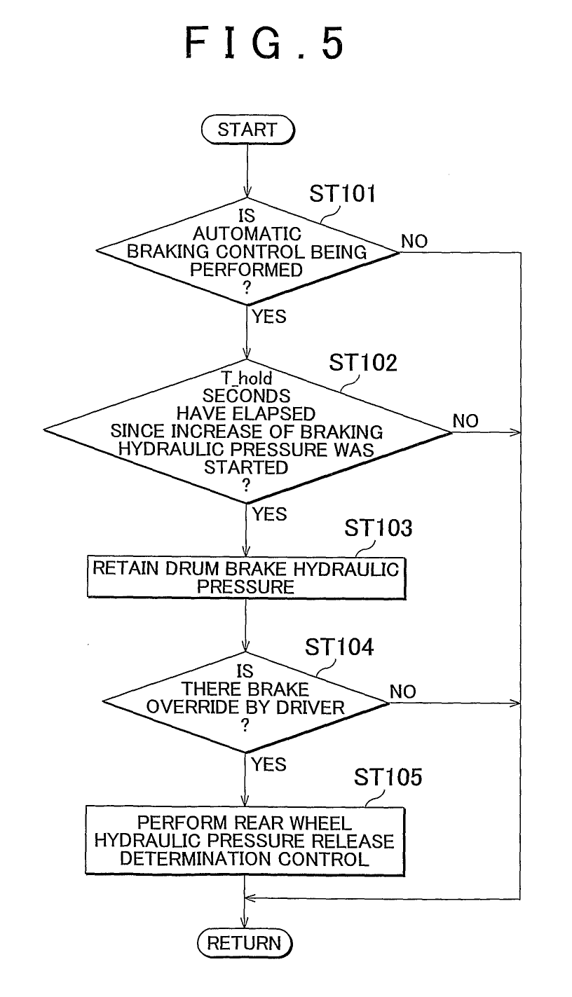

FIG. 5 is a flow chart showing a processing procedure of the automatic vehicle braking system according to this embodiment. Next, a method of performing control performed by the automatic vehicle braking system 102 according to this embodiment, that is, the processing procedure of the automatic vehicle braking system 102 will be described. The following process is called and executed at predetermined intervals when the respective portions are controlled while the vehicle 101 is running. In the processing procedure of the automatic vehicle braking system 102 according to this embodiment, it is determined whether the automatic braking control is being performed (step ST 101). This determination is performed by the automatic braking control determination section 194 that the processing section 181 of the ECU 180 has. When the automatic braking control determination section 194 determines whether the automatic braking control is being performed, it is determined whether the brakes 130 are actuated according to the control performed by the automatic braking control section 187 that the processing section 181 of the ECU 180 has. When the brakes 130 are actuated according to the control performed by the automatic braking control section 187, the automatic braking control determination section 194 determines that the automatic braking control is being performed, and when the brakes 130 are not actuated according to the control performed by the automatic braking control section 187, the automatic braking control determination section 194 determines that the automatic braking control is not being performed. When it is determined as a result of this determination that the automatic braking control is not being performed, the processing procedure is exited.

When it is determined that the automatic braking control is being performed in the determination (step ST101) by the automatic braking control determination section 194, it is then determined whether T_hold seconds have elapsed since an increase of the braking hydraulic pressure was started (step ST102). This determination is performed by the elapsed time determination section 191 that the automatic braking control section 187 has. In the case where the automatic braking control section 187 performs the automatic braking control, when the driving motor 166 is activated by the hydraulic pressure control section 190 to start the increase of the hydraulic pressure applied to the brakes 130 with the use of the compressor pump 164 when the automatic braking control is started, the timer (not shown) that the ECU 180 has is started. When the elapsed time determination section 191 determines whether T_hold seconds have elapsed since the increase of the braking hydraulic pressure was started, it is determined whether T_hold seconds have already elapsed in this timer. This period of time T_hold is stored in the storage section 1100 of the ECU 180 in advance as a predetermined period of time in which it is possible to raise the hydraulic pressure applied to the wheel cylinders 136 of the drum brakes 135 to a predetermined hydraulic pressure after the increase of the braking hydraulic pressure is started. When it is determined as a result of the determination by the elapsed time determination section 191 that T_hold seconds have not elapsed since the increase of the braking hydraulic pressure was started, the processing procedure is exited.

The period of time T_hold used in the determination by the elapsed time determination section 191 may be fixed at a certain period of time and stored in the storage section 1100 of the ECU 180 in advance. Alternatively, the period of time T_hold may be varied according to the target braking force derived by the following distance control section 186. In the case where T_hold is varied according to the target braking force, a map of the relation between the target braking force and T_hold is prepared in advance and stored in the storage section 1100 of the ECU 180, and when the target braking force is derived by the following distance control section 186, T_hold is derived by referring to the map.

When it is determined that T_hold seconds have elapsed since the increase of the braking hydraulic pressure was started in the determination (step ST102) by the elapsed time determination section 191, the hydraulic pressure applied to the drum brakes 135 is retained (step ST103). Specifically, the hydraulic pressure applied to the wheel cylinders 136 of the drum brakes 135 provided for the rear wheels 107 is maintained at a retention hydraulic pressure that is a predetermined hydraulic pressure. The retention hydraulic pressure is a retention applied force that is a predetermined applied force that is applied to the drum brakes 135. When the hydraulic pressure applied to the wheel cylinders 136 of the drum brakes 135 is retained, the pressure retaining solenoid valves 162 that are provided in the hydraulic system 150 between the master cut solenoid valves 161 and the wheel cylinders 136 of the drum brakes 135 are actuated by the hydraulic pressure control section 190 that the automatic braking control section 187 has, whereby the hydraulic pressure is retained.

The pressure retaining solenoid valves 162 are normally-open solenoid valves. When the pressure retaining solenoid valves 162 are actuated and closed, the brake fluid in the hydraulic system 150 between the pressure retaining solenoid valves 162 and the wheel cylinders 136 of the drum brakes 135 cannot flow out of this part of the hydraulic system 150. Thus, the hydraulic pressure in this part of the hydraulic system 150 is prevented from changing from the hydraulic pressure immediately before the pressure retaining solenoid valves 162 are closed and the hydraulic pressure is retained. In this way, the hydraulic pressure applied to the wheel cylinders 136 of the drum brakes 135 provided for the rear wheels 107 is retained.

While the automatic braking control is being performed by the automatic braking control section 187, the automatic braking control section 187 performs control of the deceleration of the vehicle 101 by adjusting only the hydraulic pressure applied to the disc brakes 131 after starting maintaining the hydraulic pressure applied to the drum brakes 135 at the retention hydraulic pressure. Specifically, the brake actuator 160 is controlled by the hydraulic pressure control section 190 to adjust the hydraulic pressure applied to the wheel cylinders 132 of the disc brakes 131, whereby deceleration is controlled so that the deceleration of the vehicle 101 becomes the desired deceleration.

The pressure retaining solenoid valves 162 are provided for each of the first and second hydraulic systems 151 and 152 of the hydraulic system 150 and the wheel cylinders 136 of the drum brakes 135 are connected to respective parts of the hydraulic system 150. When the pressure retaining solenoid valves 162 are closed, the pressure retaining solenoid valve 162 provided for each of these parts of the hydraulic system 150 between the master cut solenoid valves 161 and the wheel cylinders 136 of the drum brakes 135 is closed.

Next, it is determined whether there is a brake override by the driver (step ST104). This determination is performed by the braking operation determination section 192 that the automatic braking control section 187 has. The braking operation determination section 192 determines whether a braking operation is being performed, by determining whether stop lumps (not shown) provided at the rear end of the vehicle 101 are in an ON state, that is, in a lighting-up state. Specifically, because the stop lumps are turned on to light up when the driver of the vehicle 101 performs a braking operation and depresses the brake pedal 122, the braking operation determination section 192 acquires the state of the stop lumps. When the stop lumps are in an ON state, it is determined that there is a brake override that is a braking operation by the driver of the vehicle 101 while the automatic braking control is performed. On the other hand, when the stop lumps are in an OFF state, it is determined that there is no brake override. When it is determined that a braking operation is not being performed, based on this determination, the processing procedure is exited.

When it is determined by the braking operation determination section 192 whether there is a brake override, the travel of the brake pedal 122 while the automatic braking control is performed is acquired by the brake pedal travel acquisition section 183 that the processing section 181 of the ECU 180 has, based on the detection result of the brake pedal travel sensor 172. When the acquired brake pedal travel is zero, it may be determined that the braking operation is not being performed while the automatic braking control is being performed and that there is no brake override. When the acquired brake pedal travel is not zero, it may be determined that there is a brake override. When it is determined that there is no brake override by the driver in the determination by the braking operation determination section 192, the processing procedure is exited.

When it is determined that there is a brake override by the driver in the determination (step ST104) by the braking operation determination section 192, the rear-wheel hydraulic pressure release determination control is performed (step ST105). The rear-wheel hydraulic pressure release determination control is performed by the rear-wheel hydraulic pressure release determination control section 193 that the automatic braking control section 187 has. When the rear-wheel hydraulic pressure release determination control is performed by the rear-wheel hydraulic pressure release determination control section 193, a signal is transmitted to the hydraulic pressure control section 190 so that the pressure retaining solenoid valves 162 that are closed are gradually opened. Then, the hydraulic pressure control section 190 gradually opens the pressure retaining solenoid valves 162 that are provided in the hydraulic system 150 between the master cut solenoid valves 161 and the wheel cylinders 136 of the drum brakes 135. Specifically, the duty ratio used when opening and closing of the pressure retaining solenoid valves 162 are controlled is gradually changed, whereby the pressure retaining solenoid valves 162 that are fully closed are gradually opened. In this way, the hydraulic pressure applied to the wheel cylinders 136 of the drum brakes 135 is gradually changed from the hydraulic pressure immediately before the pressure retaining solenoid valves 162 are closed, that is, from the retention hydraulic pressure that is a hydraulic pressure maintained at the level obtained by pressurization by the compressor pump 164 to the hydraulic pressure generated based on the braking operation by the driver.

When the automatic braking control is performed, the above-described automatic vehicle braking system 102 makes the degree of contribution of the adjustment of the applied force applied to the disc brakes 131 to the control of the deceleration greater than the degree of contribution of the adjustment of the applied force applied to the drum brakes 135 to the control of the deceleration when the deceleration of the vehicle 101 is controlled. Thus, when the automatic braking control is performed, the influence of the braking force of the drum brakes 135 on the deceleration of the vehicle 101 is reduced, so that it is possible to suppress the instability of the deceleration of the vehicle 101 caused by adjusting the braking force of the drum brakes 135 of which the braking force is difficult to control. As a result, it is possible to stabilize braking when the automatic braking is performed.

When the automatic braking control is performed, the hydraulic pressure applied to the drum brakes 135 is not adjusted and the deceleration of the vehicle 101 is controlled by adjusting only the applied force applied to the disc brakes 131, so that it is possible to more reliably suppress the instability of the deceleration of the vehicle 101 caused by adjusting the braking force of the drum brakes 135 of which the braking force is difficult to control. As a result, it is possible to more reliably stabilize braking during automatic braking.

In addition, it is possible to improve the accuracy in controlling the braking force by excepting the braking force of the drum brakes 135 that have a high hydraulic rigidity from the subjects to be controlled and feedback-controlling only the braking force of the disc brakes 131 when the braking force is feedback-controlled using the deceleration of the vehicle 101 when the automatic braking control is performed. As a result, it is possible to stabilize braking while maintaining a desired braking force during automatic braking.

When the automatic braking control is performed, the hydraulic pressure applied to the drum brakes 135 is maintained at the retention hydraulic pressure and therefore, the drum brakes 135 continue to generate the braking force corresponding to the retention hydraulic pressure due to the application of the retention hydraulic pressure. Thus, when the automatic braking control is performed, it is possible to control the deceleration of the vehicle 101 by the disc brakes 131 while maintaining a certain amount of braking force by the drum brakes 135. As a result, it is possible to stabilize braking while maintaining a desired amount of braking force during automatic braking.

In addition, when the automatic braking control is performed, it is possible to reduce the braking force generated by the disc brakes 131 by maintaining the hydraulic pressure applied to the drum brakes 135 at a retention hydraulic pressure to allow the braking force to be continuously generated. As a result, it is possible to suppress the wear of the brake pads 133 of the disc brakes 131.

Because the hydraulic pressure in the drum brakes 135 is maintained at the retention hydraulic pressure by starting maintaining the hydraulic pressure applied to the drum brakes 135 after T_hold seconds have elapsed since the automatic braking control was started, it is possible to more reliably bring the braking force of the drum brakes 135 to a desired braking force. Specifically, although the change in the braking force of the drum brakes 135 in response to the change in the hydraulic pressure varies depending on the ranges of the hydraulic pressure, the braking force increases regardless of the degree of change in the braking force when the hydraulic pressure is increased. Thus, by increasing the hydraulic pressure with time after the start of the automatic braking control and starting maintaining the hydraulic pressure applied to the drum brakes 135 after T_hold seconds have elapsed, it is possible to more reliably bring the hydraulic pressure to the retention hydraulic pressure, which is a hydraulic pressure that can generate a certain amount of braking force by the drum brakes 135. In this way, during the automatic braking control, it is possible to more reliably maintain a certain amount of braking force by the drum brakes 135. As a result, it is possible to stabilize braking while more reliably maintaining a desired braking force during the automatic braking.

In addition, when maintaining the hydraulic pressure applied to the drum brakes 135 is started after T_hold seconds have elapsed since the automatic braking control was started and the hydraulic pressure in the drum brakes 135 is thus maintained at the retention hydraulic pressure, it is possible to cancel the ineffective travel in the early stage of increasing the hydraulic pressure applied to the drum brakes 135. As a result, it is possible to more reliably generate the braking force in the drum brakes 135 and secure a desired braking force during the automatic braking.

When the driver performs a braking operation during the automatic braking control, that is, when the driver performs a brake override, the hydraulic pressure applied to the drum brakes 135 is gradually brought from the retention hydraulic pressure to the hydraulic pressure corresponding to the braking operation by performing the rear-wheel hydraulic pressure release determination control. Thus, it is possible to avoid the situation where the braking force of the drum brakes 135 is rapidly brought to the braking force corresponding to the braking operation. Specifically, the driver performs a brake override mainly when the deceleration of the vehicle 101 due to the automatic braking control is less than the deceleration desired by the driver, and therefore, the hydraulic pressure corresponding to the braking operation by the driver is higher than the retention hydraulic pressure. Thus, when the hydraulic pressure applied to the drum brakes 135 is rapidly brought from the retention hydraulic pressure to the hydraulic pressure corresponding to the braking operation, a high hydraulic pressure is suddenly applied to the drum brakes 135 and therefore, there are a case where the braking force rapidly increases to cause a rapid change in the deceleration and a case where the rear wheels 107 that are braked by the drum brakes 135 slip relative to the road surface.

On the other hand, in the case where the hydraulic pressure applied to the drum brakes 135 is gradually brought from the retention hydraulic pressure to the hydraulic pressure corresponding to the braking operation, even when the there is a large difference between the retention hydraulic pressure and the hydraulic pressure corresponding to the braking operation, it is possible to avoid the situation where a high hydraulic pressure is suddenly applied to the drum brakes 135. Thus, even when there is a large difference between the retention hydraulic pressure and the hydraulic pressure corresponding to the braking operation, it is possible to avoid the situation where the braking force of the drum brakes 135 is rapidly brought to the braking force corresponding to the braking operation. As a result, it is possible to stabilize braking during the automatic braking, and suppress the rapid change in deceleration when braking is performed based on a braking operation during the automatic braking.

In the case where there is a large difference between the retention hydraulic pressure and the hydraulic pressure corresponding to the braking operation, when the hydraulic pressure applied to the drum brakes 135 is rapidly brought from the retention hydraulic pressure to the braking force corresponding to the braking operation by rapidly opening the pressure retaining solenoid valves 162 that are closed, the brake fluid in the hydraulic system 150 between the master cylinder 141 and the pressure retaining solenoid valves 162 rapidly flows into the hydraulic system 150 between the pressure retaining solenoid valves 162 and the wheel cylinders 136 of the drum brakes 135. Thus, the amount of brake fluid in the master cylinder 141 is rapidly reduced and the brake pedal 122 to which the force of the operation by the driver is applied can significantly dive due to the operation force.

However, in the automatic vehicle braking system 102 according to this embodiment, when the driver performs a braking operation during the automatic braking control, the duty ratio for the pressure retaining solenoid valves 162 is gradually changed and the degree of opening of the valves is gradually increased from the fully closed state. In this way, even when the pressure retaining solenoid valves 162 that are closed are opened, it is possible to inhibit the brake fluid in the hydraulic system 150 between the master cylinder 141 and the pressure retaining solenoid valves 162 from rapidly flowing into the hydraulic system 150 between the pressure retaining solenoid valves 162 and the wheel cylinders 136 of the drum brakes 135. Thus, it is possible to suppress the rapid decrease in the amount of brake fluid in the master cylinder 141 and to inhibit the brake pedal 122 from diving. As a result, it is possible to inhibit the brake pedal 122 from diving to suppress driver's uncomfortable feeling when the brake pedal 122 is operated during the automatic braking control.

The disc-side wheels, which are the wheels 105 to be braked by the disc brakes 131, are used as the front wheels 106 and the drum-side wheels, which are the wheels 105 to be braked by the drum brakes 135, are used as the rear wheels 107. Thus, it is possible to easily bring the deceleration of the vehicle 101 closer to a desired deceleration. Specifically, when the vehicle 101 is braked, a larger load is exerted on the front wheels 106 as compared to the rear wheels 107, and therefore, it is possible to make the braking force of the front wheels 106 greater than the braking force of the rear wheels 107. Thus, the proportion of the braking force of the rear wheels 107 to the braking force of the entire vehicle 101 is less than the proportion of the braking force of the front wheels 106 thereto. Thus, the influence of the braking force of the rear wheels 107 on the braking force of the entire vehicle 101 is relatively small and therefore, it is possible to easily bring the deceleration of the vehicle 101 closer to a desired deceleration even when, during the automatic braking, the braking force of the rear wheels 107, which are the drum-side wheels, is kept constant and the deceleration of the vehicle 101 is controlled by only the braking force of the front wheels 106, which are the disc-side wheels. As a result, it is possible to bring the deceleration of the vehicle 101 closer to the desired deceleration while stabilizing braking during the automatic braking.

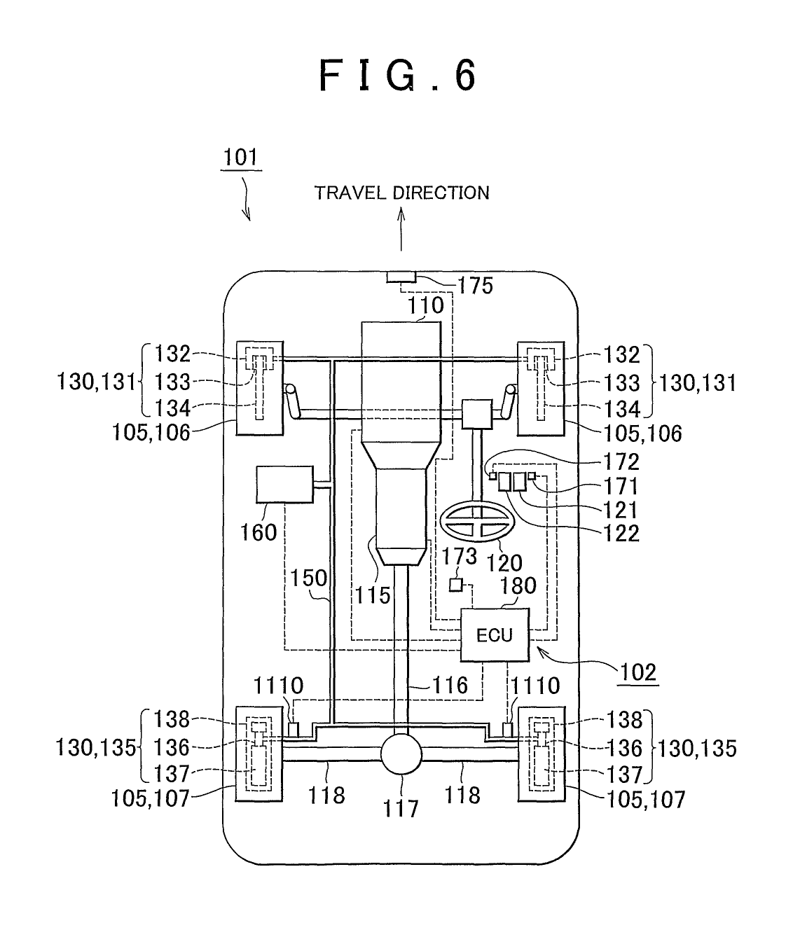

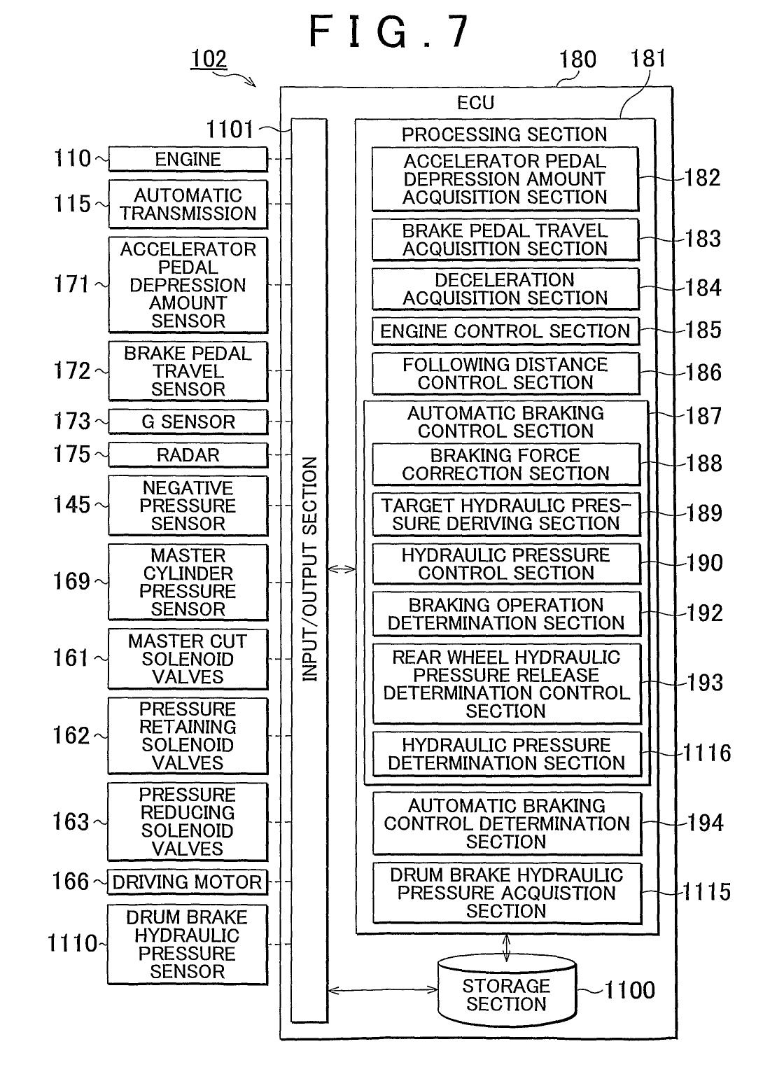

FIG. 6 is a schematic diagram of a vehicle provided with the automatic vehicle braking system according to a modification of the first embodiment. FIG. 7 is a main part configuration diagram of the automatic vehicle braking system shown in FIG. 6. When the hydraulic pressure in the drum brakes 135 is maintained at the retention hydraulic pressure during the automatic braking control, in the automatic vehicle braking system 102, the hydraulic pressure is maintained at the retention hydraulic pressure by closing the pressure retaining solenoid valves 162 when T_hold seconds have elapsed since an increase of the braking hydraulic pressure was started. However, maintaining the hydraulic pressure in the drum brakes 135 at the retention hydraulic pressure may be performed by another method. For example, the hydraulic pressure may be maintained at the retention hydraulic pressure by a method in which the hydraulic pressure applied to the wheel cylinders 136 of the drum brakes 135 is detected and when the detected hydraulic pressure reaches the retention hydraulic pressure, the pressure retaining solenoid valves 162 are closed.

In this case, as shown in FIG. 6, the drum brake hydraulic pressure sensor 1110, which functions as the drum-side applied force detection means that detects the hydraulic pressure applied to the drum brakes 135, is provided in the hydraulic system 150 from the brake actuator 160 to the drum brakes 135. The drum brake hydraulic pressure sensor 1110 is connected to the ECU 180. In the processing section 181 of the ECU 180, as shown in FIG. 7, a drum brake hydraulic pressure acquisition section 1115 is provided, which functions as the drum-side applied force acquisition means that acquires the drum brake hydraulic pressure that is a hydraulic pressure applied to the wheel cylinders 136 of the drum brakes 135 from the result of the detection by the drum brake hydraulic pressure sensor 1110. The automatic braking control section 187 that the ECU 180 has is provided with, instead of the elapsed time determination section 191 (see FIG. 3), a hydraulic pressure determination section 1116, which functions as the hydraulic pressure determination means that determines whether the drum brake hydraulic pressure acquired by the drum brake hydraulic pressure acquisition section 1115 has reached the retention hydraulic pressure.

A retention hydraulic pressure P_RrMPa that is a reference value used to determine whether the drum brake hydraulic pressure should be retained is stored in the storage section 1100 of the ECU 180 in advance. The retention hydraulic pressure P_RrMPa may be a fixed pressure or may be varied according to the target braking force derived by the following distance control section 186 as in the case of T_hold. When the retention hydraulic pressure P_RrMPa is varied according to the target braking force, a map representing the relation between the target braking force and the retention hydraulic pressure P_RrMPa is prepared in advance and stored in the storage section 1100 of the ECU 180 and when the target braking force is derived by the following distance control section 186, the retention hydraulic pressure P_RrMPa is derived by referring to the map.

When the automatic braking control is performed by the automatic vehicle braking system 102, after the automatic braking control is started, the drum brake hydraulic pressure is detected by the drum brake hydraulic pressure sensor 1110 and acquired by the drum brake hydraulic pressure acquisition section 1115, and the hydraulic pressure determination section 1116 determines whether the acquired drum brake hydraulic pressure has reached the retention hydraulic pressure P_RrMPa. When as a result of this determination, it is determined that the drum brake hydraulic pressure has reached the retention hydraulic pressure P_RrMPa, the hydraulic pressure applied to the drum brakes 135 is retained by closing the pressure retaining solenoid valves 162 (see FIG. 2) provided in the hydraulic system 150 from the master cut solenoid valves 161 (see FIG. 2) to the wheel cylinders 136 of the drum brakes 135.

If the hydraulic pressure in the drum brakes 135 is maintained at the retention hydraulic pressure P_RrMPa by starting retaining the hydraulic pressure applied to the drum brakes 135 when the hydraulic pressure applied to the drum brakes 135 that is detected by the drum brake hydraulic pressure sensor 1110 has reached the retention hydraulic pressure P_RrMPa, it is possible to more reliably bring the braking force of the drum brakes 135 to the desired braking force. Specifically, the drum brake hydraulic pressure sensor 1110 that detects the hydraulic pressure applied to the drum brakes 135 is provided and when the result of the detection by the drum brake hydraulic pressure sensor 1110 becomes the retention hydraulic pressure, the hydraulic pressure applied to the drum brakes 135 is retained. In this way, it is possible to more reliably maintain this hydraulic pressure at the retention hydraulic pressure that is a hydraulic pressure that can generate a certain braking force in the drum brakes 135. Thus, during the automatic braking control, it is possible to more reliably maintain a certain braking force by the drum brakes 135. As a result, it is possible to stabilize braking while maintaining a desired braking force during the automatic braking.

Next, a second embodiment of the invention will be described. With regard to the part similar to the first embodiment, description is omitted as appropriate.

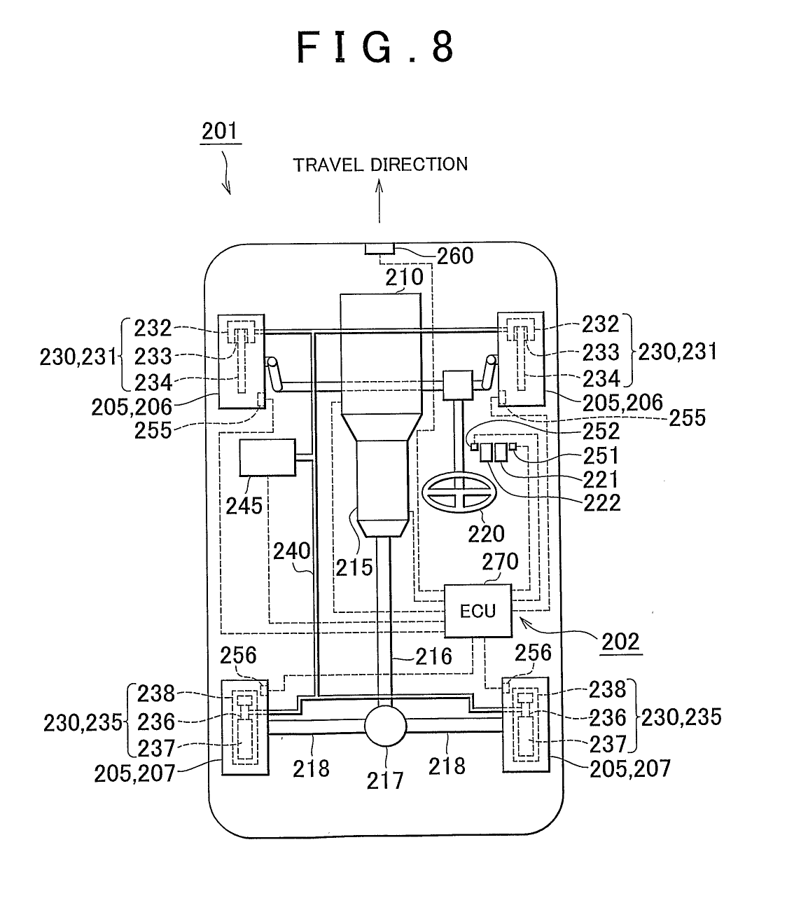

FIG. 8 is a schematic diagram of a vehicle provided with an automatic vehicle braking system according to the second embodiment of the invention. Disc brakes 231 and drum brakes 235 are connected to a hydraulic system 240 composed of lines for applying hydraulic pressure to the disc brakes 231 and the drum brakes 235 when the vehicle 201 is braked. Specifically, wheel cylinders 232 of the disc brakes 231 and wheel cylinders 236 of the drum brakes 235 are connected to the hydraulic system 240. The hydraulic system 240 is provided with a brake actuator 245 that controls the hydraulic pressure in the hydraulic system 240 when the vehicle 201 is braked. The brake actuator 245 controls hydraulic pressure, which is used as the applied force that is applied to the disc brakes 231 and the drum brakes 235, by one control system. Specifically, when the vehicle 201 is braked, the hydraulic pressure used to actuate the brakes 230 is controlled in such a manner that the control of the disc brakes 231 and the control of the drum brakes 235 are not performed independently of each other.

Front wheels 206 are each provided with a front-wheel longitudinal force sensor 255, which functions as the disc-side wheel braking force detection means that detects the braking force of the front wheel 206. Rear wheels 207 are each provided with a rear-wheel longitudinal force sensor 256, which functions as the drum-side wheel braking force detection means that detects the braking force of the rear wheel 207. The front-wheel longitudinal force sensors 255 and the rear-wheel longitudinal force sensors 256 are provided so as to be able to detect the strain in the rotation direction between a portion closer to the central axis and a portion closer to the periphery with respect to the radial direction of the wheel 205.

Thus, at the time of braking, it is possible to detect the force exerted, in the longitudinal direction of the vehicle, on the wheel 205 provided with the front-wheel longitudinal force sensor 255 or the rear-wheel longitudinal force sensor 256, that is, it is possible to detect the braking force, by detecting the strain during braking. Specifically, at the time of braking, the brake 230 exerts the force to slow down the rotation of the wheel 205 on the wheel 205, so that a strain occurs in the rotation direction between a portion closer to the central axis and a portion closer to the periphery with respect to the radial direction of the wheel 205. Thus, a large strain during a braking implies that the braking force of the wheel 205 is large, and a small strain during a braking implies that the braking force of the wheel 205 is small.

In the vehicle 201, an accelerator pedal 221 operated when the output power from the engine 210 is controlled and a brake pedal 222 operated when the running vehicle 201 is braked are both provided close to the feet of the driver who sits on the driver's seat of the vehicle 201. In the vicinity of the accelerator pedal 221, an accelerator pedal depression amount sensor 251, which functions as the accelerator pedal depression amount detection means that detects the amount of depression of the accelerator pedal 221, is provided. In the vicinity of the brake pedal 222, a brake pedal travel sensor 252, which functions as the brake pedal travel detection means that detects the travel of the brake pedal 222, is provided.

At the front end of the vehicle 201 with respect to the travel direction, a radar 260 directed forward is disposed as the travel direction conditions detection means. The radar 260 includes a radiating section (not shown) that radiates electromagnetic waves in the travel direction of the vehicle 201 and a detection section (not shown) that, when the electromagnetic waves radiated from the radiating section are reflected by an obstacle located in the travel direction of the vehicle 201, detects the reflected electromagnetic waves. The radar 260 is provided so as to be able to detect the conditions in an area in the travel direction of the vehicle 201 by detecting the electromagnetic waves that are radiated from the radiating section and reflected by an obstacle.

The travel direction conditions detection means may differ from the radar 260. For example, the travel direction conditions detection means may be a charge coupled device (CCD) camera capable of detecting the conditions in an area in the travel direction of the vehicle 201 in the form of picked-up image information, for example. The travel direction conditions detection means is not limited as long as it can detect the conditions in an area in the travel direction of the vehicle 201.

The engine 210, the automatic transmission 215, the brake actuator 245, the accelerator pedal depression amount sensor 251, the brake pedal travel sensor 252, the front-wheel longitudinal force sensors 255, the rear-wheel longitudinal force sensors 255, and the radar 260 are connected to an electronic control unit (ECU) 270 that is installed in the vehicle 201 and controls respective portions of the vehicle 201.

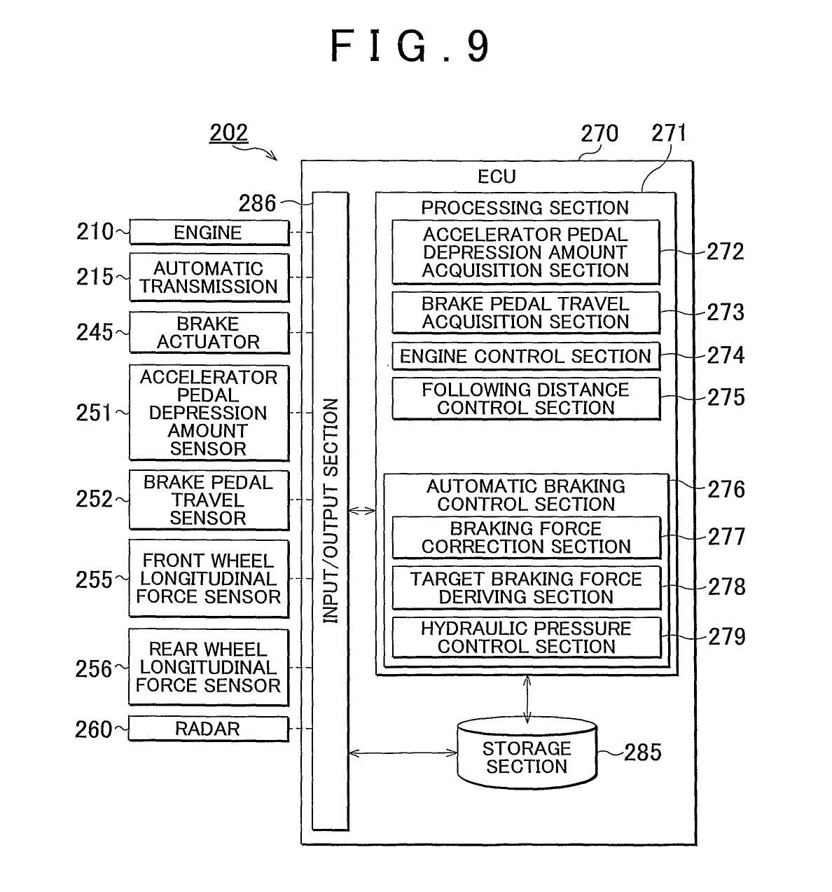

FIG. 9 is a main part configuration diagram of the automatic vehicle braking system shown in FIG. 8. The ECU 270 includes a processing section 271, a storage section 285, and an input/output section 286, which are connected to each other, and signals are exchanged therebetween. The engine 210, an automatic transmission 215, the brake actuator 245, the accelerator pedal depression amount sensor 251, the brake pedal travel sensor 252, the front-wheel longitudinal force sensors 255, the rear-wheel longitudinal force sensors 256, and the radar 260, which are connected to the ECU 270, are connected to the input/output section 286. The input/output section 286 supplies and receives signals to and from the front-wheel longitudinal force sensors 255 etc. The storage section 285 stores a computer program for controlling the automatic vehicle braking system 202. The storage section 285 can be a hard disk drive, a magneto-optical disk device, a nonvolatile memory such as a flash memory (a read-only storage medium such as a CD-ROM), or a volatile memory such as a random access memory (RAM), or the storage section 285 can be constructed as a combination of these memories.

In addition, the processing section 271 is made up of a memory and a central processing unit (CPU) and at least includes: an accelerator pedal depression amount acquisition section 272, which functions as the accelerator pedal operation amount acquisition means that acquires the accelerator pedal depression amount from the result of the detection by the accelerator pedal depression amount sensor 251; a brake pedal travel acquisition section 273, which functions as the braking operation acquisition means that acquires the travel of the brake pedal 222 from the result of the detection by the brake pedal travel sensor 252; an engine control section 274, which functions as the engine control means that controls the operating conditions of the engine 210; and a following distance control section 275, which functions as the following distance control means that performs control to keep the following distance between the host vehicle and a vehicle running ahead of the host vehicle appropriate based on the result of the detection by the radar 260 and deriving the target braking force for keeping the following distance between the host vehicle and the vehicle running ahead of the host vehicle appropriate.

The processing section 271 also includes an automatic braking control section 276, which functions as the automatic braking control means that performs automatic braking control in which the hydraulic pressure applied to the disc brakes 231 and the drum brakes 235 is controlled independently of the braking operation by the driver of the vehicle 201 when the wheels 205 are braked by the disc brakes and the drum brakes, and that performs feedback control of the hydraulic pressure based only on the result of the detection of the braking force by the front-wheel longitudinal force sensors 255 during a period of time during which the braking force of the drum brakes 135 is unstable in the early stage of braking. The automatic braking control section 276 includes: a braking force correction section 277, which functions as the braking force correction means that corrects the target braking force derived by the following distance control section 275 at least based on the result of the detection of the braking force by the front-wheel longitudinal force sensors 255; a target hydraulic pressure deriving section 278, which functions as the target applied force deriving means that derives the hydraulic pressure that provides the applied force required to generate the target braking force in the disc brakes 231 and the drum brakes 235; and a hydraulic pressure control section 279, which functions as the applied force control means that controls the hydraulic pressure that provides the applied force applied to the disc brakes 231 and the drum brakes 235.

The automatic vehicle braking system 202 controlled by the ECU 270 is controlled by operating the brake actuator 245 etc. in accordance with the result of computation performed by the processing section 271 after the processing section 271 reads the computer program into the memory incorporated into the processing section 271, based on the result of the detection by the front-wheel longitudinal force sensors 255, etc. for example. During this process, the processing section 271 stores intermediate values obtained in the computation into the storage section 285 and reads out the stored values to perform the computation. When the automatic vehicle braking system 202 is controlled in this way, the control may be performed using dedicated hardware separate from the ECU 270 instead of using the computer program.

The automatic vehicle braking system 202 according to the second embodiment is configured as described above and the operation thereof will be described below. When the vehicle 201 is running, the engine 210 is operated and the motive power from the engine 210 is transmitted to the rear wheels 207, which are driving wheels. More specifically, while the engine 210 is in operation, rotation of the crankshaft (not shown) that the engine 210 has is transmitted to the automatic transmission 215 and the speed is changed by the automatic transmission 215 by a ratio appropriate to the traveling conditions of the vehicle 201. The rotation changed in speed by the automatic transmission 215 is transmitted to the rear wheels 207 through a propeller shaft 216, a differential gear 217, and a drive shaft 218. Thus, the rear wheels 207, which are the driving wheels, rotate and the vehicle 201 runs.

The vehicle speed of the vehicle 201 that is driven by the rotation of the engine 210 transmitted to the rear wheels 207 is controlled by adjusting the speed and power of the engine 210 by operating the accelerator pedal 221 by a foot. When the accelerator pedal 221 is operated, the travel of the accelerator pedal 221, that is, the accelerator pedal depression amount is detected by the accelerator pedal depression amount sensor 251 provided in the vicinity of the accelerator pedal 221. The result of detection by the accelerator pedal depression amount sensor 251 is transmitted to and acquired by the accelerator pedal depression amount acquisition section 272 that the processing section 271 of the ECU 270 has, and the acquired accelerator pedal depression amount is transmitted to the engine control section 274 that the processing section 271 of the ECU 270 has. The engine control section 274 controls the engine 210 based on the accelerator pedal depression amount acquired by the accelerator pedal depression amount acquisition section 272 and on the results of detection by other sensors.

When the vehicle speed is reduced by the amount greater than the amount of reduction in speed caused by a release of the accelerator pedal 221 while the vehicle 201 is running, the vehicle 201 is braked by depressing the brake pedal 222. When the braking operation is performed by depressing the brake pedal 222, the travel of the brake pedal 222 is detected by the brake pedal travel sensor 252 provided in the vicinity of the brake pedal 222. The result of detection by the brake pedal travel sensor 252 is acquired by the brake pedal travel acquisition section 273 that the processing section 271 of the ECU 270 has.

The travel of the brake pedal 222 acquired by the brake pedal travel sensor 273 is transmitted to the hydraulic pressure control section 279 that the processing section 271 of the ECU 270 has. The hydraulic pressure control section 279 supplies, to the brake actuator 245, the electric current corresponding to the amount of travel transmitted to the brake pedal travel acquisition section 273. The brake actuator 245 is operated according to the electric current, thereby generating a hydraulic pressure. Thus, the hydraulic pressure control section 279 allows the brake actuator 245 to generate the hydraulic pressure corresponding to the travel of the brake pedal 222 acquired by the brake pedal travel acquisition section 273.

The hydraulic pressure generated by the brake actuator 245 is transmitted to the disc brakes 231 and the drum brakes 235 through the hydraulic system 240 between the brake actuator 245 and the disc brakes 231 and between the brake actuator 245 and the drum brakes 235, whereby the hydraulic pressure is applied to the disc brakes 231 and the drum brakes 235. The disc brakes 231 and the drum brakes 235 are actuated by the applied hydraulic pressure. Specifically, the hydraulic pressure applied to the disc brakes 231 and the drum brakes 235 is applied to the wheel cylinders 232 of the disc brakes 231 and the wheel cylinders 236 of the drum brakes 235, whereby the wheel cylinders 232 and 236 are actuated by the hydraulic pressure. When these wheel cylinders 232 and 236 are actuated, the wheel cylinders 232 and 236 reduce the rotation speed of brake discs 234 and brake drums 238 that are provided associated with the wheel cylinders 232 and 236 and rotate with the wheels 205 when the wheels 205 rotate.

Specifically, when the hydraulic pressure is applied to the wheel cylinders 232 of the disc brakes 231 and the wheel cylinders 232 of the disc brakes 231 are thus actuated, pressing force is applied to brake pads 233 to squeeze the brake discs 234 on opposite sides thereof. Thus, the rotation speed of the brake discs 234 is reduced by the friction between the brake discs 234 and the brake pads 233. When the hydraulic pressure is applied to the wheel cylinders 236 of the drum brakes 235 and the wheel cylinders 236 of the drum brakes 235 are thus actuated, pressing force is applied to brake shoes 237 to press against the brake drums 238 from inside. Thus, the rotation speed of the brake drums 238 is reduced by the friction between the brake drums 238 and the brake shoes 237.

As described above, when the wheel cylinders 232 of the disc brakes 231 and the wheel cylinders 236 of the drum brakes 235 are actuated by the hydraulic pressure, braking force is generated in the disc brakes 231 and the drum brakes 235 and the rotation speed of the brake discs 234 and the brake drums 238 is therefore reduced. In this way, the rotation speed of the wheels 205 is also reduced. Specifically, when the braking force is generated in the disc brakes 231, the rotation speed of the brake discs 234 is reduced and the rotation speed of the front wheels 206 that rotate with the brake discs 234 is also reduced. When the braking force is generated in the drum brakes 235, the rotation speed of the brake drums 238 is reduced and the rotation speed of the rear wheels 207 that rotate with the brake drums 238 is also reduced. In this way, braking force of the wheels 205 is generated and the speed of the vehicle 201 is reduced. Accordingly, a braking operation of the brake pedal 222 causes a braking force, which reduces the rotation speed of the brake discs 234 and the brake drums 238, to be generated in the disc brakes 231 and the drum brakes 235, and the rotation speed of the wheels 205 is reduced by the braking force, whereby the running vehicle 201 is braked. Thus, the vehicle 201 is decelerated and deceleration occurs in the vehicle 201.

The vehicle 201 including the automatic vehicle braking system 202 according to the second embodiment is capable of performing the adaptive cruise control (ACC). For example, the ACC allows the vehicle 201 to follow a vehicle running ahead of the host vehicle 201 while keeping a certain following distance, and when the distance between the host vehicle and the vehicle ahead of the host vehicle is small, the ACC performs the automatic braking control for automatic braking. When the ACC is performed, the following distance between the host vehicle and the vehicle ahead of the host vehicle is detected by the radar 260 provided at the front end of the vehicle 201 and the control is performed based on the detected distance.

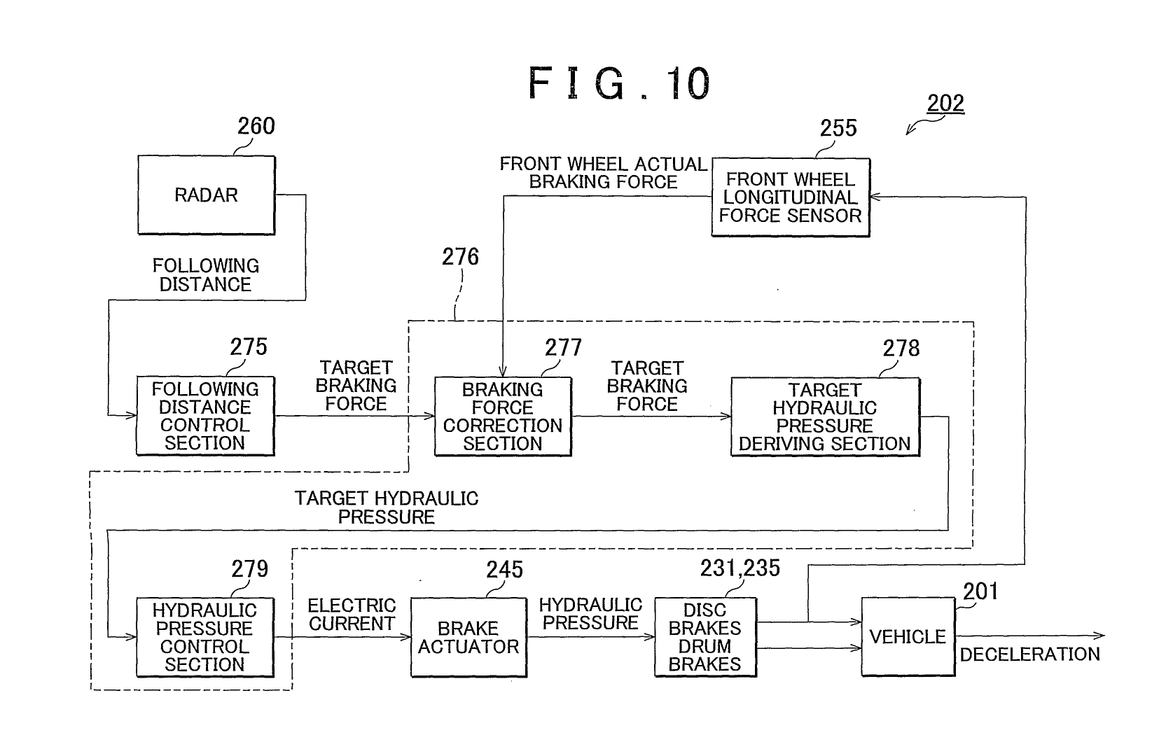

FIG. 10 is a block diagram, showing a main part of the automatic vehicle braking system shown in FIG. 8, that is an explanatory diagram for explaining the control in the early stage of braking performed by the automatic braking control. When a braking is performed by a braking operation by the driver while the vehicle 201 is running, the braking is performed by operating the brake pedal 222 as described above. In this case, the automatic braking control in the ACC control is performed by the automatic braking control section 276 that the processing section 271 of the ECU 270 has based on the result of the detection by the radar 260. When the automatic braking control section 276 performs the automatic braking control, the following distance between the host vehicle 201 and the vehicle running ahead of the host vehicle 201 with the use of the radar 260. The following distance detected by the radar 260 is transmitted to the following distance control section 275 that the processing section 271 of the ECU 270 has. In the following distance control section 275, the target braking force corresponding to the following distance is derived from the following distance detected by the radar 260. Specifically, when the following distance transmitted from the radar 260 is equal to or less than a predetermined following distance, the deceleration required to increase the following distance is derived and the target braking force required to decelerate the vehicle 201 by this deceleration is derived.

The predetermined following distance used in this determination is set for each vehicle speed in advance and stored in the storage section 285 of the ECU 270. Also in the case of target braking force, the target braking forces associated with the following distances and the vehicle speeds are set in the form of a map in advance and stored in the storage section 285.

The target braking force derived in the following distance control section 275 is transmitted to the automatic braking control section 276 that the processing section 271 of the ECU 270 has. Specifically, the target braking force is transmitted to the braking force correction section 277 that the automatic braking control section 276 has. In the early stage of braking during the automatic braking control, the braking force correction section 277 corrects the target braking force transmitted from the following distance control section 275, based on the front-wheel actual braking force that is the actual braking force of the front wheels 206 detected by the front-wheel longitudinal force sensors 255. However, immediately after the automatic braking control is started and before the front-wheel longitudinal force sensors 255 detect the front-wheel actual braking force, the braking force correction section 277 transmits the target braking force, which is transmitted from the following distance control section 275, to the target hydraulic pressure deriving section 278 that the automatic braking control section 276 has.

The target hydraulic pressure deriving section 278 to which the target braking force has been transmitted derives the hydraulic pressure required to generate the target braking force by the disc brakes 231 and the drum brakes 235, that is, the target hydraulic pressure, which is the hydraulic pressure that can generate the target braking force by applying the hydraulic pressure to the disc brakes 231 and the drum brakes 235. With regard to the method of deriving the target hydraulic pressure by the target hydraulic pressure deriving section 278, a brake inverse model (not shown) made up of the relation between the braking force and the hydraulic pressure is stored in the storage section 285 of the ECU 270 in advance, and the hydraulic pressure corresponding to the target braking force is derived from the target braking force transmitted from the braking force correction section 277 and the brake inverse model stored in the storage section 285. This is used as the target hydraulic pressure. The target hydraulic pressure derived by the target hydraulic pressure deriving section 278 is transmitted to the hydraulic pressure control section 279 that the automatic braking control section 276 has.

The hydraulic pressure control section 279 to which the target hydraulic pressure has been transmitted derives the amount of electric current that can operate the brake actuator 245 by the amount of work that can generate the target hydraulic pressure and supplies the electric current to the brake actuator 245. The brake actuator 245 that receives the electric current from the hydraulic pressure control section 279 is operated by this electric current and generates a hydraulic pressure. In this case, the hydraulic pressure has already been brought to a hydraulic pressure substantially equal to the target hydraulic pressure.

The hydraulic pressure generated by the brake actuator 245 is transmitted and applied to the disc brakes 231 and the drum brakes 235 via the hydraulic system 240. The disc brakes 231 and the drum brakes 235 are actuated by this hydraulic pressure and generate braking force. The braking force generated by the disc brakes 231 is used as the braking force of the front wheels 206 and the braking force generated by the drum brakes 235 is used as the braking force of the rear wheels 207. Such braking force reduces the rotation speed of the wheels 205 and deceleration corresponding to the braking force occurs in the vehicle 201.

In the early stage of braking during the automatic braking control, specifically, during the period of time during which the braking force of the drum brakes 235 is unstable in the early stage of braking, out of the braking force of the front wheels 206 and the rear wheels 207, the front-wheel actual braking force, which is the actual braking force of the front wheels 206, is detected by the front-wheel longitudinal force sensors 255 and transmitted to the braking force correction section 277. Specifically, out of the braking force of the front wheels 206 and the rear wheels 207, the braking force of the front wheels 206 is fed back.

The braking force correction section 277 to which the front-wheel actual braking force is transmitted from the front-wheel longitudinal force sensors 255 corrects the target braking force transmitted from the following distance control section 275, based on the front-wheel actual braking force. When the target braking force is corrected by the braking force correction section 277, first, by multiplying the target braking force by the coefficient representing the proportion of the braking force of the front wheels 206 to the braking force of the entire vehicle 201, the front-wheel target braking force, which is, out of the entire target braking force, the target braking force that is born by the front wheels 206. After the front-wheel target braking force is computed, the amount of feedback is computed based on the difference between the computed front-wheel target braking force and the front-wheel actual braking force transmitted from the front-wheel longitudinal force sensors 255. The amount of feedback thus computed is added to the target braking force transmitted from the following distance control section 275 to adjust the target braking force, whereby the braking force of the four wheels is apparently adjusted and corrected.

When the target braking force is corrected based on the front-wheel actual braking force, the correction may be made by feedback control based on the front-wheel actual braking force into which the braking forces of the right and left, two front wheels 206 are combined. Alternatively, the correction may be made by feedback control based on the respective front-wheel actual braking forces of the right and left front wheels 206. This also applies when the target braking force is corrected by feedback control based on the rear-wheel actual braking force as described below.

The target braking force corrected by the braking force correction section 277 is transmitted to the target hydraulic pressure deriving section 278 and the target hydraulic pressure is derived by the target hydraulic pressure deriving section 278 based on the target braking force after correction. Specifically, the target hydraulic pressure is derived that can generate the target braking force after correction by applying the hydraulic pressure to the disc brakes 231 and the drum brakes 235.

Upon receipt of the target hydraulic pressure from the target hydraulic pressure deriving section 278, the hydraulic pressure control section 279 derives the amount of electric current that can generate the target hydraulic pressure and supplies the electric current to the brake actuator 245. The brake actuator 245 is operated by this electric current to generate the hydraulic pressure. The disc brakes 231 and the drum brakes 235 are actuated by the hydraulic pressure applied and the front wheels 206 and the rear wheels 207 generate the braking force. The braking force generated in this way is a braking force resulting from the feedback control in which the front-wheel actual braking force is fed back. Specifically, in the early stage of braking by the automatic braking control, the braking force is controlled by the feedback control in which only the actual braking force of the front wheels 206 is fed back.

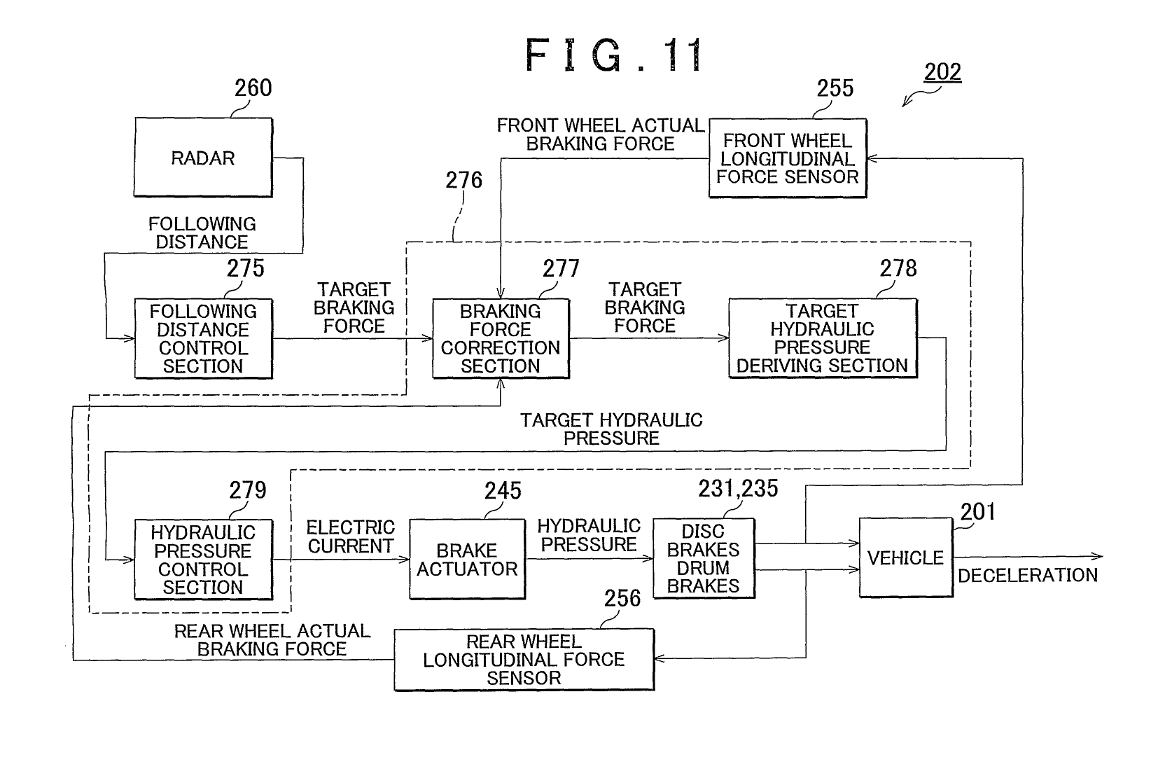

FIG. 11 is a block diagram, showing the main part of the automatic vehicle braking system shown in FIG. 8, that is an explanatory diagram for explaining the control in the case where the automatic braking control is performed for a predetermined period of time. When the automatic braking control is performed, during the period of time during which the braking force of the drum brakes 235 is unstable in the early stage of braking, the actual braking force of the front wheels 206 only is fed back to perform control. After this period of time has elapsed, the actual braking force of the rear wheels 207 is also fed back to perform control. Specifically, after the period of time during which the braking force of the drum brakes 235 is unstable has elapsed, the rear-wheel actual braking force that is the actual braking force of the rear wheels 207 is detected by the rear-wheel longitudinal force sensor 256 and transmitted to the braking force correction section 277. After the period of time during which the braking force of the drum brakes 235 is unstable has elapsed, both the braking force of the front wheels 206 and the braking force of the rear wheels 207 are fed back.

The braking force correction section 277, to which the front-wheel actual braking force and the rear-wheel actual braking force have been transmitted from the front-wheel longitudinal force sensor 255 and the rear-wheel longitudinal force sensor 256, corrects the target braking force transmitted from the following distance control section 275, based on the front-wheel actual braking force and the rear-wheel actual braking force. When the target braking force is corrected in the braking force correction section 277, first, the front-wheel target braking force, which is, out of the target braking force, the target braking force that is born by the front wheels 206, and the rear-wheel target braking force, which is, out of the target braking force, the target braking force that is born by the rear wheels 207 are computed by multiplying the braking force of the entire vehicle 201 by the coefficient representing the proportion of the braking force of the front wheels 206 to the braking force of the entire vehicle 201 and by multiplying the braking force of the entire vehicle 201 by the coefficient representing the proportion of the braking force of the rear wheels 207 to the braking force of the entire vehicle 201.

After the front-wheel target braking force and the rear-wheel target braking force are computed, the amount of feedback is computed based on the difference between each of the target braking forces, and the front-wheel actual braking force and the rear-wheel actual braking force transmitted from the front-wheel longitudinal force sensor 255 and the rear-wheel longitudinal force sensor 256, respectively. Specifically, the amount of feedback based on the difference between the front-wheel target braking force and the front-wheel actual braking force and the amount of feedback based on the difference between the rear-wheel target braking force and the rear-wheel actual braking force are computed. The amount of feedback computed in this way is added to the target braking force transmitted from the following distance control section 275 to adjust the target braking force, whereby the braking force of the four wheels is adjusted and controlled.

After the target braking force is corrected, the target hydraulic pressure is derived based on the target braking force after correction by the target hydraulic pressure deriving section 278 similarly to the method used during the period of time during which the braking force of the drum brakes 235 is unstable. Then, the amount of electric current that can generate the target hydraulic pressure is derived by the hydraulic pressure control section 279 and the brake actuator 245 is operated by this electric current. In this way, the brake actuator 245 is operated and a hydraulic pressure is generated, whereby the disc brakes 231 and the drum brakes 235 are actuated by this hydraulic pressure to generate the braking force of the front wheels 206 and the rear wheels 207. The braking force generated in this way is a braking force resulting from the feedback control in which the front-wheel actual braking force and the rear-wheel actual braking force are fed back. Thus, after the period of time has elapsed during which the braking force of the drum brakes 235 is unstable in the early stage of braking during the automatic braking control, control is performed by the feedback control in which the actual braking force of the front wheels 206 and the actual braking force of the rear wheels 207 are fed back.

The determination as to whether the period of time has elapsed during which the braking force of the drum brakes 235 is unstable in the early stage of braking during the automatic braking control may be made based on a fixed period of time or may be made by referring to a map that is prepared in advance by setting the time periods associated with vehicle speeds and hydraulic pressures generated by the brake actuator 245 and stored in the storage section 285 of the ECU 270. Alternatively, whether the unstable time period has elapsed may be determined by constantly detecting the rear-wheel actual braking force by the rear-wheel longitudinal force sensor 256 even during the time period during which the braking force of the drum brakes 235 is unstable and determining whether the result of detection is stable.

As described above, the automatic vehicle braking system 202 detects the front-wheel actual braking force that is the actual braking force of the front wheels 206 by the front-wheel longitudinal force sensor 255 and when the automatic braking control is performed by the automatic braking control section 276, the feedback control of the braking force is performed based only on the result of the detection by the front-wheel longitudinal force sensors 255 during the time period during which the braking force of the drum brakes 235 is unstable. Thus, the braking force of the drum brakes 235 during the time period during which the braking force is unstable, that is, the rear-wheel actual braking force during this time period is not reflected in the control of the hydraulic pressure of the disc brakes 231 and the drum brakes 235, so that it is possible to avoid the situation where the hydraulic pressure becomes unstable due to the feedback of the unstable braking force and the braking force therefore becomes further unstable, resulting in the occurrence of hunting. As a result, it is possible to stabilize braking in the early stage of braking during the automatic braking.

Because the control of the hydraulic pressure of the disc brakes 231 and the control of the hydraulic pressure of the drum brakes 235 are not performed independently, it is easy to control the hydraulic pressure when the automatic braking control is performed. Specifically, even when the feedback control is performed based only on the result of the detection by the front-wheel longitudinal force sensor 255 during a period of time during which the braking force of the drum brakes 235 is unstable, the hydraulic pressure of the disc brakes 231 and the hydraulic pressure of the drum brakes 235 are both controlled by the feedback control using one feedback amount. Thus, it is easy to control the hydraulic pressure generated by the brake actuator 245 when the automatic braking control is performed by the feedback control. As a result, it is facilitated to stabilize the braking in the early stage of braking during the automatic braking.

After the period of time has elapsed during which the braking force of the drum brakes 235 is unstable, the feedback control of the hydraulic pressure is performed using also the result of the detection of the braking force by the rear-wheel longitudinal force sensors 256, so that it is possible to more appropriately control the hydraulic pressure. Specifically, after the period of time has elapsed during which the braking force of the drum brakes 235 is unstable when the automatic braking control is performed, what are fed back are not only the braking force exerted by the disc brakes 231, which is fed back by feeding back the front-wheel actual braking force, but also the braking force exerted by the drum brakes 235, which is fed back by feeding back the rear-wheel actual braking force. In this way, when the braking control is performed so that the actual braking force is brought to the target braking force, the actual braking force is more reliably brought closer to the target braking force. As a result, it is possible to perform the braking control during the automatic braking with the braking force as desired while stabilizing the braking in the early stage of braking during the automatic braking.

The disc-side wheels, which are wheels 205 to be braked by the disc brakes 231, are used as the front wheels 206 and the drum-side wheels, which are wheels 205 to be braked by the drum brakes 235, are used as the rear wheels 207. Thus, it is possible to bring the braking force in the early stage of braking closer to the target braking force. Specifically, when the vehicle 201 is braked, a larger load is exerted on the front wheels 206 as compared to the rear wheels 207, and therefore, it is possible to make the braking force of the front wheels 206 greater than the braking force of the rear wheels 207. Thus, the proportion of the braking force of the rear wheels 207 to the braking force of the entire vehicle 201 is less than the proportion of the braking force of the front wheels 206 thereto. Thus, the influence of the braking force of the rear wheels 207 on the braking force of the entire vehicle 201 is relatively small, so that it is possible to bring the braking force of the entire vehicle 201 closer to the target braking force even when only the braking force of the front wheels 206, which are the disc-side wheels, is fed back and the braking force of the rear wheels 207, which are the drum-side wheels, is not fed back in the early stage of braking. As a result, it is possible to bring the braking force in the early stage of braking closer to the desired braking force while stabilizing braking in the early stage of braking during the automatic braking.

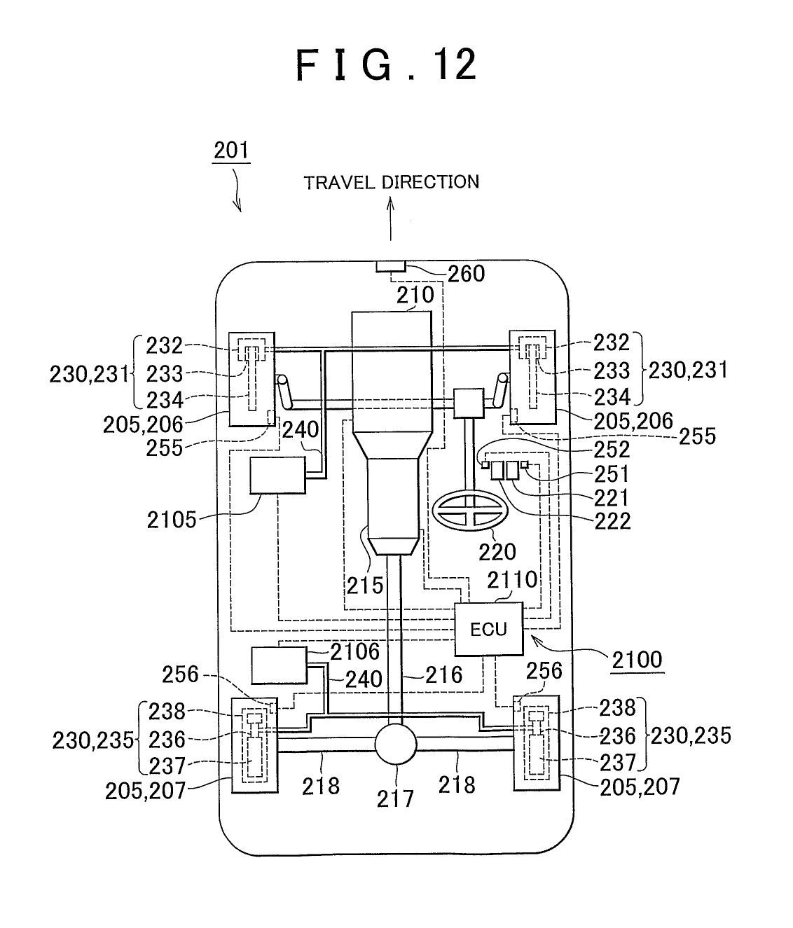

Next, a third embodiment of the invention will be described. An automatic vehicle braking system 2100 according to the third embodiment is configured similarly to the automatic vehicle braking system 202 according to the second embodiment, except that the automatic vehicle braking system 2100 is characterized in that the hydraulic pressure of the disc brakes 231 and that of the drum brakes 235 are controlled independently of each other. Other components are similar to those of the second embodiment and therefore, the description thereof is omitted and such components are designated by the same reference numerals, respectively. FIG. 12 is a schematic diagram of a vehicle provided with the automatic vehicle braking system according to the third embodiment of the invention. In the automatic vehicle braking system 2100 according to the third embodiment, similarly to the automatic vehicle braking system 202 of the second embodiment, the front wheels 206 are provided so as to be braked by the disc brakes 231 and the rear wheels 207 are provided so as to be braked by the drum brakes 235. The brake actuators, which generate the hydraulic pressure to actuate the disc brakes 231 and the drum brakes 235, are provided for the disc brakes 231 and for the drum brakes 235. The brake actuator for the disc brakes 231 is a front-wheel brake actuator 2105 and the brake actuator for the drum brakes 235 is a rear-wheel brake actuator 2106.

The front-wheel brake actuator 2105 and the rear-wheel brake actuator 2106 are both connected to an ECU 2110. The braking force of the disc brakes 231 is controlled by controlling the hydraulic pressure generated in the front-wheel brake actuator 2105 and the braking force of the drum brakes 235 is controlled by controlling the hydraulic pressure generated by the rear-wheel brake actuator 2106. In this way, in the automatic vehicle braking system 2100 according to the third embodiment, the disc brakes 231 and the drum brakes 235 are provided so that the hydraulic pressures are controlled independently of each other.

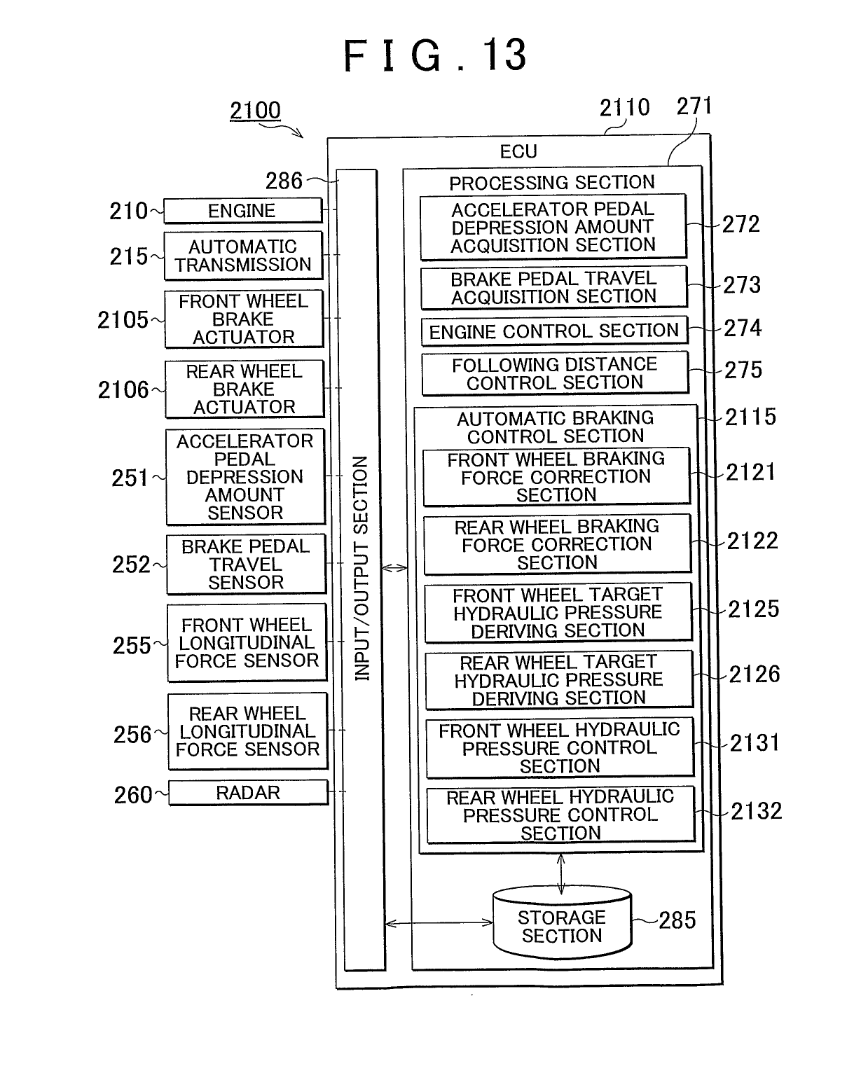

FIG. 13 is a main part configuration diagram of the automatic vehicle braking system shown in FIG. 12. The ECU 2110 that the automatic vehicle braking system 2100 according to the third embodiment has includes the processing section 271, the storage section 285, and the input/output section 286, similarly to the ECU 270 that the automatic vehicle braking system 202 according to the second embodiment has. The processing section 271 of the ECU 2110 includes the accelerator pedal depression amount acquisition section 272, the brake pedal travel acquisition section 273, the engine control section 274, the following distance control section 275, and an automatic braking control section 2115, similarly to the ECU 270 that the automatic vehicle braking system 202 according to the second embodiment has.

The automatic braking control section 2115 that the processing section 271 of the ECU 2110 has includes: a front-wheel braking force correction section 2121, which functions as the disc-side wheel braking force correction means that corrects the target braking force derived in the following distance control section 275, based on the result of the detection of the braking force by the front-wheel longitudinal force sensor 255; a rear-wheel braking force correction section 2122, which functions as the drum-side wheel braking force correction means that corrects the target braking force derived in the following distance control section 275, based on the result of the detection of the braking force by the rear-wheel longitudinal force sensor 256; a front-wheel target hydraulic pressure deriving section 2125, which functions as the disc-side wheel target applied force deriving means that derives the hydraulic pressure that provides the applied force required to generate the target braking force in the disc brakes 231; a rear-wheel target hydraulic pressure deriving section 2126, which functions as the drum-side wheel target applied force deriving means that derives the hydraulic pressure that provides the applied force required to generate the target braking force in the drum brakes 235; a front-wheel hydraulic pressure control section 2131, which functions as the disc-side wheel applied force control means that controls the hydraulic pressure that provides the applied force applied to the disc brakes 231; and a rear-wheel hydraulic pressure control section 2132, which functions as the drum-side wheel applied force control means that controls the hydraulic pressure that provides the applied force applied to the drum brakes 235.

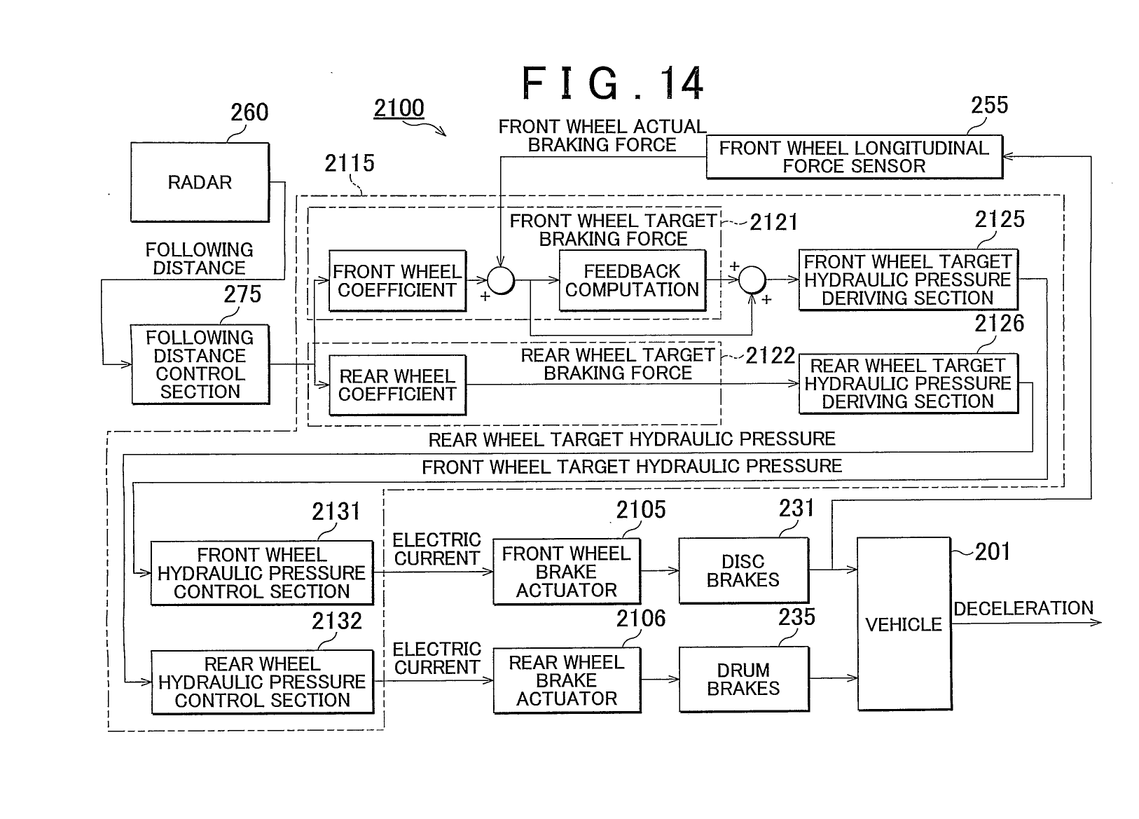

The automatic vehicle braking system 2100 according to the third embodiment is configured as described above and the operation will be described below. FIG. 14 is an explanatory diagram for explaining the control performed in the early stage of braking when the automatic braking control is performed by the automatic vehicle braking system according to the third embodiment. When the automatic braking control is performed during the ACC control, the target braking force corresponding to the following distance is derived by the following distance control section 275, based on the following distance detected by the radar 260. The target braking force derived in the following distance control section 275 is transmitted to the front-wheel braking force correction section 2121 and the rear-wheel braking force correction section 2122 that the automatic braking control section 2115 has. The front-wheel braking force correction section 2121 computes the front-wheel target braking force, which is, out of the entire target braking force, the target braking force that is born by the front wheels 206, by multiplying the target braking force of the entire vehicle 201 by a front wheel coefficient that is a coefficient representing the proportion of the braking force of the front wheels 206 to the braking force of the entire vehicle 201. Similarly, the rear-wheel braking force correction section 2122 computes the rear-wheel target braking force, which is, out of the entire target braking force, the target braking force that is born by the rear wheels 207, by multiplying the target braking force of the entire vehicle 201 by a rear wheel coefficient that is a coefficient representing the proportion of the braking force of the rear wheels 207 to the braking force of the entire vehicle 201.

When the automatic braking control is performed, during the time period during which the braking force of the drum brakes 235 is unstable in the early stage of braking, out of the front-wheel actual braking force and the rear-wheel actual braking force, the front-wheel actual braking force only is detected by the front-wheel longitudinal force sensor 255 and transmitted to the front-wheel braking force correction section 2121 as in the case of the automatic vehicle braking system 202 according to the second embodiment. In this way, the front-wheel braking force correction section 2121 to which the front-wheel actual braking force has been transmitted from the front-wheel longitudinal force sensor 255 performs computation for feedback based on the difference between the front-wheel target braking force computed by the front-wheel braking force correction section 2121 and the front-wheel actual braking force transmitted from the front-wheel longitudinal force sensor 255. In this way, the front-wheel target braking force is corrected. The front-wheel target braking force corrected by the front-wheel braking force correction section 2121 is transmitted to the front-wheel target hydraulic pressure deriving section 2125 that the automatic braking control section 2115 has.

The front-wheel target hydraulic pressure deriving section 2125 derives the front-wheel target hydraulic pressure, which is the hydraulic pressure required to generate the front-wheel target braking force after correction by the disc brakes 231, based on the front-wheel target braking force transmitted from the front-wheel braking force correction section 2121. When the front-wheel target hydraulic pressure is derived by the front-wheel target hydraulic pressure deriving section 2125, the front-wheel target hydraulic pressure is derived based on the front-wheel target braking force, using the brake inverse model stored in the storage section 285 of the ECU 2110 in advance. The front-wheel target hydraulic pressure derived by the front-wheel target hydraulic pressure deriving section 2125 is transmitted to the front-wheel hydraulic pressure control section 2131 that the automatic braking control section 2115 has.

The front-wheel hydraulic pressure control section 2131 to which the front-wheel target hydraulic pressure has been transmitted derives the amount of electric current that can generate the front-wheel target hydraulic pressure and supplies the electric current to the front-wheel brake actuator 2105. The front-wheel brake actuator 2105 is operated by the electric current to generate the hydraulic pressure and the hydraulic pressure is applied to the disc brakes 231, whereby the disc brakes 231 are actuated. In this way, the braking force of the front wheels 206 is generated. The braking force of the front wheels 206 is the braking force resulting from the feedback control in which the front-wheel actual braking force is fed back.

As described above, feedback control is performed for the braking force of the front wheels 206, whereas the braking force of the rear wheels 207 is controlled without the feedback control during the time period during which the braking force of the drum brakes 235 is unstable in the early stage of braking during the automatic braking. Specifically, the rear-wheel target braking force derived by the rear-wheel braking force correction section 2122 is transmitted unchanged to the rear-wheel target hydraulic pressure deriving section 2126 that the automatic braking control section 2115 has, without performing computation for feedback.

The rear-wheel target hydraulic pressure deriving section 2126 derives the rear-wheel target hydraulic pressure, which is the hydraulic pressure required to generate the rear-wheel target braking force by the drum brakes 235, based on the rear-wheel target braking force transmitted from the rear-wheel braking force correction section 2122. When the rear-wheel target braking force is derived by the rear-wheel target hydraulic pressure deriving section 2126, the rear-wheel target hydraulic pressure is derived based on the rear-wheel target braking force, using the brake inverse model stored in the storage section 285 of the ECU 2110 in advance. The rear-wheel target hydraulic pressure derived by the rear-wheel target hydraulic pressure deriving section 2126 is transmitted to the rear-wheel hydraulic pressure control section 2132 that the automatic braking control section 2115 has.

The rear-wheel hydraulic pressure control section 2132 to which the rear-wheel target hydraulic pressure has been transmitted derives the amount of electric current that can generate the rear-wheel target hydraulic pressure and supplies the electric current to the rear-wheel brake actuator 2106. The rear-wheel brake actuator 2106 is operated by the electric current to generate the hydraulic pressure and the hydraulic pressure is applied to the drum brakes 235, whereby the drum brakes 235 are actuated. In this way, the braking force of the rear wheels 207 is generated. The braking force of the rear wheels 207 is controlled without feedback control in the early stage of braking during the automatic braking control. As described above, in the automatic vehicle braking system 2100 according to the third embodiment, the disc brakes 231 and the drum brakes 235 are independently controlled and when the vehicle 201 is braked, the deceleration corresponding to the braking force of the disc brakes 231 and the drum brakes 235 that are independently controlled occurs in the vehicle 201.

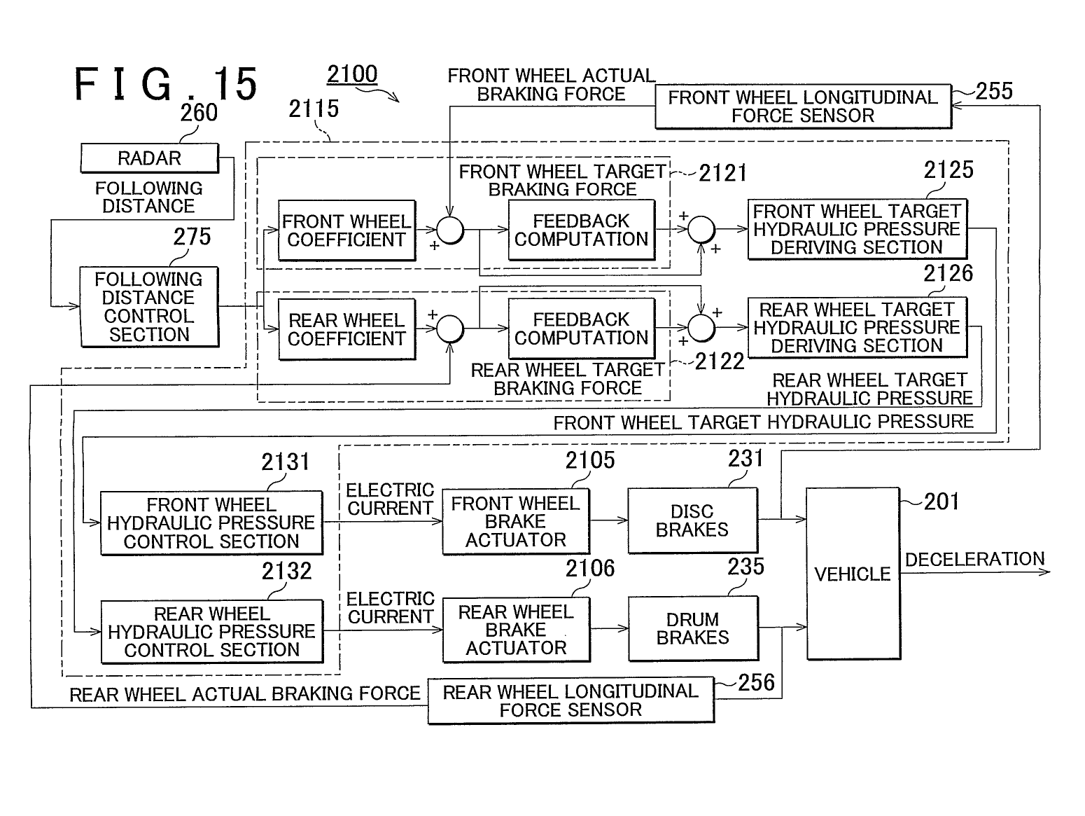

FIG. 15 is an explanatory diagram for explaining the control performed after the predetermined period of time has elapsed in the case where the automatic braking control is performed by the automatic vehicle braking system according to the third embodiment. In the automatic vehicle braking system 2100 according to the third embodiment, the control of the braking force differs between during the period of time during which the braking force of the drum brakes 235 is unstable in the early stage of braking during the automatic braking control and after this time period has elapsed. After this time period has elapsed, the braking force of the rear wheels 207 is also feedback-controlled. Specifically, after the time period has elapsed during which the braking force of the drum brakes 235 is unstable, the rear-wheel actual braking force is detected by the rear-wheel longitudinal force sensor 256 and transmitted to the rear-wheel braking force correction section 2122.

The rear-wheel braking force correction section 2122 to which the rear-wheel actual braking force has been transmitted from the rear-wheel longitudinal force sensor 256 performs computation for feedback based on the difference between the rear-wheel target braking force computed by the rear-wheel braking force correction section 2122 and the rear-wheel actual braking force transmitted from the rear-wheel longitudinal force sensor 256. In this way, the rear-wheel target braking force is corrected.

The rear-wheel target braking force corrected by the rear-wheel braking force correction section 2122 is transmitted to the rear-wheel target hydraulic pressure deriving section 2126 that the automatic braking control section 2115. The rear-wheel target hydraulic pressure deriving section 2126 derives the rear-wheel target hydraulic pressure based on the rear-wheel target braking force, using the brake inverse model stored in the storage section 285 of the ECU 2110.

The rear-wheel target hydraulic pressure derived by the rear-wheel target hydraulic pressure deriving section 2126 is transmitted to the rear-wheel hydraulic pressure control section 2132 that the automatic braking control section 2115 has. The rear-wheel target hydraulic pressure control section 2132 derives the amount of electric current that can generate the rear-wheel target hydraulic pressure and supplies the electric current to the rear-wheel brake actuator 2106. In this way, the rear-wheel brake actuator 2106 generates a hydraulic pressure and the drum brakes 235 are actuated by this hydraulic pressure, whereby the braking force of the rear wheels 207 is generated. The braking force of the rear wheels 207 is the braking force resulting from the feedback control in which the rear-wheel actual braking force is fed back.

As described above, in the automatic vehicle braking system 2100 according to the third embodiment, as in the case of the automatic vehicle braking system 202 according to the second embodiment, after the period of time has elapsed during which the braking force of the drum brakes 235 is unstable in the early stage of braking during the automatic braking control, control is performed by the feedback control in which the actual braking force of the front wheels 206 and the actual braking force of the rear wheels 207 are fed back.

The automatic vehicle braking system 2100 described above is provided so that the control of the hydraulic pressure of the disc brakes 231 and the control of the hydraulic pressure of the drum brakes 235 are performed independently of each other. Thus, even during the time period during which the braking force of the drum brakes 235 is unstable, braking control for the disc brakes 231 can be performed by feedback control. Specifically, by controlling the hydraulic pressure of the disc brakes 231 and the drum brakes 235 independently, it is possible to feedback-control only the barking force of the disc brakes 231 during the time period during which the braking force of the drum brake 235 is unstable. Thus, even during the time period during which the braking force of the drum brakes 235 is unstable, it is possible to stabilize the braking force of the disc brakes 231 and thus stabilize the braking force of the front wheels 206. As a result, it is possible to more reliably stabilize the braking in the early stage of braking during the automatic braking.

As described above, the automatic vehicle braking system according to the invention is useful for vehicles in which both disc brakes and drum brakes are used, and is suitable especially when automatic braking control is performed.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

1. An automatic vehicle braking system comprising:
a plurality of wheels of a vehicle, including a disc-side wheel that is braked by a disc brake and a drum-side wheel that is braked by a drum brake; and
an automatic braking control section that performs automatic braking control in which applied force applied to the disc brake and the drum brake is controlled independently of a braking operation performed by a driver of the vehicle when the wheels are braked by the disc brake and the drum brake, and that, during the automatic braking control, makes a degree of contribution of adjustment of the applied force applied to the disc brake to control of deceleration of the vehicle greater than a degree of contribution of adjustment of the applied force applied to the drum brake to the control of the deceleration when the deceleration of the vehicle is controlled.

2. The automatic vehicle braking system according to claim 1, wherein during the automatic braking control, the automatic braking control section controls the deceleration by adjusting only the applied force applied to the disc brake.

3. The automatic vehicle braking system according to claim 1 or 2, wherein during the automatic braking control, the automatic braking control section maintains the applied force applied to the drum brake at a retention applied force that is a predetermined amount of the applied force.

4. The automatic vehicle braking system according to claim 3, wherein the automatic braking control section starts maintaining the applied force at the retention applied force after a predetermined period of time has elapsed since the automatic braking control was started.

5. The automatic vehicle braking system according to claim 3, further comprising a drum-side applied force detection device that detects the applied force applied to the drum brake,
wherein the automatic braking control section starts maintaining the applied force applied to the drum brake at the retention applied force when the applied force applied to the drum brake that is detected by the drum-side applied force detection device becomes the retention applied force.

6. The automatic vehicle braking system according to any one of claims 1 to 5, wherein the automatic braking control section gradually brings the applied force applied to the drum brake to an applied force corresponding to the braking operation when the braking operation is performed during the automatic braking control.

7. The automatic vehicle braking system according to any one of claims 1 to 6, wherein the disc-side wheel is provided as a front wheel of the vehicle and the drum-side wheel is provided as a rear wheel of the vehicle.

8. An automatic vehicle braking system comprising:
a plurality of wheels of a vehicle, including a disc-side wheel that is braked by a disc brake and a drum-side wheel that is braked by a drum brake;
a disc-side wheel braking force detection device that detects a braking force of the disc-side wheel; and
an automatic braking control section that performs automatic braking control in which applied force applied to the disc brake and the drum brake is controlled independently of a braking operation performed by a driver of the vehicle when the wheels are braked by the disc brake and the drum brake, and that performs feedback control of the applied force based only on the braking force detected by the disc-side wheel braking force detection device.

9. The automatic vehicle braking system according to claim 8, wherein the automatic braking control section performs the feedback control of the applied force based only on the braking force detected by the disc-side wheel braking force detection device during a period of time during which a braking force of the drum brake is unstable in an early stage of braking.

10. The automatic vehicle braking system according to claim 8 or 9, wherein control of the applied force of the disc brake and control of the applied force of the drum brake are not performed independently of each other.

11. The automatic vehicle braking system according to claim 8 or 9, wherein the disc brake and the drum brake are provided so that the control of the applied force of the disc brake and the control of the applied force of the drum brake can be performed independently of each other.

12. The automatic vehicle braking system according to any one of claims 9 to 11, further comprising a drum-side wheel braking force detection device that detects the braking force of the drum-side wheel,
wherein the automatic braking control section performs the feedback control of the applied force using both the braking force detected by the disc-side wheel braking force detection device and the braking force detected by the drum-side wheel braking force detection device after the period of time during which the braking force of the drum brake is unstable has elapsed.

13. The automatic vehicle braking system according to any one of claims 8 to 12, wherein the disc-side wheel is provided as a front wheel of the vehicle and the drum-side wheel is provided as a rear wheel of the vehicle.

14. A method of performing automatic braking of a vehicle that has a plurality of wheels including a disc-side wheel that is braked by a disc brake and a drum-side wheel that is braked by a drum brake, the method comprising,
when the plurality of wheels are braked by the disc brake and the drum brake, controlling applied force applied to the disc brake and the drum brake independently of a braking operation performed by a driver of the vehicle,
wherein a degree of contribution of adjustment of the applied force applied to the disc brake to control of deceleration of the vehicle is made greater than a degree of contribution of adjustment of the applied force applied to the drum brake to the control of the deceleration when the deceleration of the vehicle is controlled.

15. A method of performing automatic braking of a vehicle that has a plurality of wheels including a disc-side wheel that is braked by a disc brake and a drum-side wheel that is braked by a drum brake, the method comprising,
when the plurality of wheels are braked by the disc brake and the drum brake, controlling applied force applied to the disc brake and the drum brake independently of a braking operation performed by a driver of the vehicle,
wherein feedback control of the applied force is performed based only on the braking force detected by a disc-side wheel braking force detection device that detects a braking force of the disc-side wheel.
